(19) United States
(12) Patent Application Publication
(10) Pub. No.: US 2025/0021153 A1
(43) Pub. Date: Jan. 16, 2025

(54) ADAPTIVE LOW-POWER SIGNALING TO ENABLE LINK SIGNAL ERROR RECOVERY WITHOUT INCREASED LINK CLOCK RATES

(71) Applicant: QUALCOMM Incorporated, San Diego, CA (US)

(72) Inventors: Nan ZHANG, Beijing (CN); Long HAN, Shanghai (CN); Junqiang GUO, Tianjin (CN)

(21) Appl. No.: 18/715,968

(22) PCT Filed: Feb. 24, 2022
(86) PCT No.: PCT/CN2022/077592

§ 371 Date: Jun. 3, 2024

(51) Int. Cl. G06F 1/3234; G06F 1/3215; G09G 5/00

(52) U.S. Cl. CPC G06F 1/3253; G06F 1/3215; G09G 5/006; G09G 2330/021

(57) ABSTRACT

An error recovery method for a display system interface includes configuring a physical layer circuit in the display system interface for a high-speed mode of communication, causing the physical layer circuit to transmit display data over a serial bus while the physical layer circuit is configured for the high-speed mode of communication, halting transmission of the display data when an error indication signal transitions to an active state, configuring the physical layer circuit for a low-power mode of communication after terminating the transmission of the display data, reconfiguring the physical layer circuit for the high-speed mode of communication when the error indication signal transitions to an inactive state, and causing the physical layer circuit to resume the transmission of the display data after reconfiguring the physical layer circuit for the high-speed mode of communication.

### TECHNICAL FIELD

The present disclosure relates generally to serial communication over a serial bus in a wireless communication device and, more particularly, to error correction for a display serial interface bus.

### BACKGROUND

Mobile communication devices typically include a variety of components such as circuit boards, integrated circuit (IC) devices, application-specific integrated circuit (ASIC) devices and/or System-on-Chip (SoC) devices. The types of components may include processing circuits, user interface components, storage and other peripheral components that communicate over a serial bus. The serial bus may be operated in accordance with a standardized or proprietary protocol. In one example, a serial bus can be operated in accordance with an Inter-Integrated Circuit (I2C or I2C) communication protocol. The I2C bus is configured as a multi-drop bus and was developed to connect low-speed peripherals to a processor. The two wires of an I2C bus include a Serial Data Line (SDA) that carries a data signal, and a Serial Clock Line (SCL) that carries a clock signal.

A serial bus can be operated in accordance with a multi-master protocol and one or more devices may be a designated as a bus master or controller for the serial bus in some transmissions and as a slave or respondent device for other transmissions. In one example, Improved Inter-Integrated Circuit (I3C) protocols may be used to control operations on a serial bus. I3C protocols are defined by the Mobile Industry Processor Interface (MIPI) Alliance and derive certain implementation aspects from the I2C protocol. In another example, the Radio Frequency Front-End (RFFE) interface defined by the MIPI Alliance provides a communication interface for controlling various radio frequency (RF) front-end devices, including power amplifiers (PAs), low-noise amplifiers (LNAs), antenna tuners, filters, sensors, power management devices, switches, etc. These devices may be collocated in a single IC device or provided in multiple IC devices. Multiple antennas and radio transceivers may be provided in a mobile communication device to support multiple concurrent RF links. In another example, the system power management interface (SPMI) defined by the MIPI Alliance provides a hardware interface that may be implemented between baseband or application processors and peripheral components. The SPMI is often deployed to support power management operations within a device or system.

Multiple standards are defined for interconnecting certain types of components in mobile communication devices. For example, there are multiple types of interfaces defined for communication between an application processor and display or camera components in a mobile communication device. Some components employ an interface that conforms to one or more standards or protocols specified by the MIPI Alliance, including standards and protocols for a camera serial interface (CSI) and a display serial interface (DSI).

The MIPI Alliance DSI, DSI-2 (referred to individually or collectively as DSI) and CSI-2, standards define wired interfaces that can be deployed within or between IC devices and/or SoC devices to couple a camera and application processor using CSI protocols, or to couple an application processor and display using DSI protocols. The low-level physical-layer (PHY) interface in each of these applications can be implemented in accordance with MIPI Alliance C-PHY or D-PHY standards and protocols. High-speed modes and low-power modes of communication are defined for C-PHY and D-PHY interfaces. The C-PHY high-speed mode uses a low-voltage multiphase signal transmitted in different phases on a 3-wire link. The D-PHY high-speed mode uses a plurality of 2-wire lanes to carry low-voltage differential signals. The low-power modes of C-PHY and D-PHY interfaces provide lower rates than the high-speed modes and transmits signals at higher voltages.

As device technology improves, a combination of demands for higher data rates over serial buses and the use of multiple mode display panels has generated greater needs for reliable transmission of high-volume display data over the serial buses used to communicate image and display data. Higher data transmission rates can lead to higher transmission error rates, thereby reducing the nominally available data rate of the serial buses. There is an ongoing need to improve serial bus interfaces to provide higher data throughput while minimizing the impact of transmission errors.

### SUMMARY

Certain aspects of the disclosure relate to systems, apparatus, methods and techniques that provide improved error detection and rapid recovery techniques that enable high-volume display data to be transmitted at high data rates over serial buses that experience frequent transmission errors.

In various aspects of the disclosure, a display system interface for a transmitting device includes a physical layer circuit coupled to a serial bus and configurable to operate in accordance with Mobile Industry Processor Interface (MIPI) Alliance display serial interface (DSI) specifications and a controller configured to monitor an error indication signal received from a receiving device coupled to the serial bus. The controller may configure the physical layer circuit for a high-speed mode of communication, cause the physical layer circuit to transmit display data over the serial bus while the physical layer circuit is configured for the high-speed mode of communication, halt transmission of the display data when the error indication signal transitions to an active state, configure the physical layer circuit for a low-power mode of communication after terminating the transmission of the display data, reconfigure the physical layer circuit for the high-speed mode of communication when the error indication signal transitions to an inactive state and cause the physical layer circuit to resume the transmission of the display data after reconfiguring the physical layer circuit for the high-speed mode of communication.

In various aspects of the disclosure, an error recovery method for a display system interface includes configuring a physical layer circuit in the display system interface for a high-speed mode of communication, causing the physical layer circuit to transmit display data over a serial bus while the physical layer circuit is configured for the high-speed mode of communication, halting transmission of the display data when the error indication signal transitions to an active state, configuring the physical layer circuit for a low-power mode of communication after terminating the transmission of the display data, reconfiguring the physical layer circuit for the high-speed mode of communication when the error indication signal transitions to an inactive state, and causing the physical layer circuit to resume the transmission of the display data after reconfiguring the physical layer circuit for the high-speed mode of communication.

In various aspects of the disclosure, an apparatus has means for transmitting display data over a serial bus, including a physical layer circuit configurable for multiple modes of communication, and means for determining that a transmission error has been detected at the receiving device when the physical layer circuit is configured for a high-speed mode of communication. The means for determining that the transmission error has been detected may be configured to monitor an indication of the transmission error. Transmission of the display data is halted when the indication of the transmission error transitions to a first state. The physical layer circuit may be configured for a low-power mode of communication when the indication of the transmission error transitions to the first state and the physical layer circuit is reconfigured for the high-speed mode of communication when the indication of the transmission error transitions to a second state. The physical layer circuit may be configured to resume the transmission of the display data after the physical layer circuit is reconfigured for the high-speed mode of communication.

In various aspects of the disclosure, a processor readable storage medium includes code for configuring a physical layer circuit in the display system interface for a high-speed mode of communication, causing the physical layer circuit to transmit display data over the serial bus while the physical layer circuit is configured for the high-speed mode of communication, halting transmission of the display data when the error indication signal transitions to an active state, configuring the physical layer circuit for a low-power mode of communication after terminating the transmission of the display data, reconfiguring the physical layer circuit for the high-speed mode of communication when the error indication signal transitions to an inactive state and causing the physical layer circuit to resume the transmission of the display data after reconfiguring the physical layer circuit for the high-speed mode of communication.

### BRIEF DESCRIPTION OF THE DRAWINGS

FIG. 1 illustrates an apparatus employing a data link between IC devices and that is selectively operated according to a standard or proprietary protocol.

FIG. 2 illustrates a system architecture for an apparatus employing a data link between IC devices.

FIG. 3 illustrates an example of a C-PHY interface that may be adapted according to certain aspects disclosed herein.

FIG. 4 illustrates an example of a D-PHY interface that may be adapted according to certain aspects disclosed herein.

FIG. 5 illustrates examples of apparatus that may be adapted according to certain aspects disclosed herein.

FIG. 6 illustrates certain features of waveforms that relate to modes of operation defined by C-PHY and D-PHY protocols.

FIG. 7 illustrates certain physical aspects of signaling in a D-PHY interface when transitions between communication modes are occurring.

FIG. 8 illustrates transmission latency related to transitions between communication modes in the example of a D-PHY interface.

FIG. 9 illustrates transmission latency related to transitions between communication modes in the example of a C-PHY interface.

FIG. 10 illustrates a solution used to combat the effects of transmission errors in a display interface.

FIG. 11 illustrates certain aspects of a display system adapted or configured in accordance with certain aspects of this disclosure.

FIG. 12 illustrates certain aspects of the operation of the display system illustrated in FIG. 11.

FIG. 13 illustrates one example of an apparatus employing a processing circuit that may be adapted in accordance with certain aspects disclosed herein.

FIG. 14 is a flowchart that illustrates a method that may be performed by a host device that is coupled to a serial bus in accordance with certain aspects disclosed herein.

FIG. 15 illustrates a first example of a hardware implementation for a communication apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Data communication links employed by SoCs and other IC devices to connect processors with modems and other peripherals may be operated in accordance with industry or proprietary standards or protocols associated with certain functions or types of devices. In the example of display panels, display subsystems, and display drivers, communication standards and protocols defined by the MIPI Alliance are frequently used. The Display Serial Interface (DSI®), for example, provides C-PHY and D-PHY standards and protocols used to define, configure and control a high-speed serial interface between a host processor and a display module. Control and management protocols may be used to operate other serial buses that couple the host processor and display module may include SPMI, I2C, I3C and/or protocols.

In mobile communication handsets, user equipment and other devices, interfaces operated in accordance with DSI specifications or protocols are frequently used for communications between application processors and display drivers. Different modes of communication may be supported. High-speed modes of communication provide different data rates required to support high resolution displays. Transitioning between modes of communication requires reconfiguration and recalibration of the physical interface circuits coupled to the serial buses to enable the use of different frequencies for bit transmission clocks. In various applications, changes from a high-speed mode to a low-power mode is forced when a transmission error is detected. The transition to low-power mode can be performed to reset the physical interface circuits and clear the effects of transmission errors. In an interface that experiences frequent transmission errors, the forced transition to low-power mode and subsequent return to his speed mode introduces delays and can limit available throughput over a serial bus.

An error recovery technique provided in accordance with certain aspects of this disclosure can enable a transmitter to rapidly respond to a reported transmission error and can minimize the time lost in recovery from transmission errors. In one example, a physical layer circuit in a display system interface that is transmitting display data in a high-speed mode of communication may halt transmission of the display data when an error indication signal asserted or drive to an active state by a receiving device. The transmitter can then transition its physical layer circuit for a low-power mode of communication and signal the receiver in the low-power mode to reset the receiver physical interface. The transmitter may resume high-speed mode and resume transmitting the display data when the receiver de-asserts the error indication signal.

Examples of Apparatus that Employ Serial Data Links

According to certain aspects of the disclosure, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

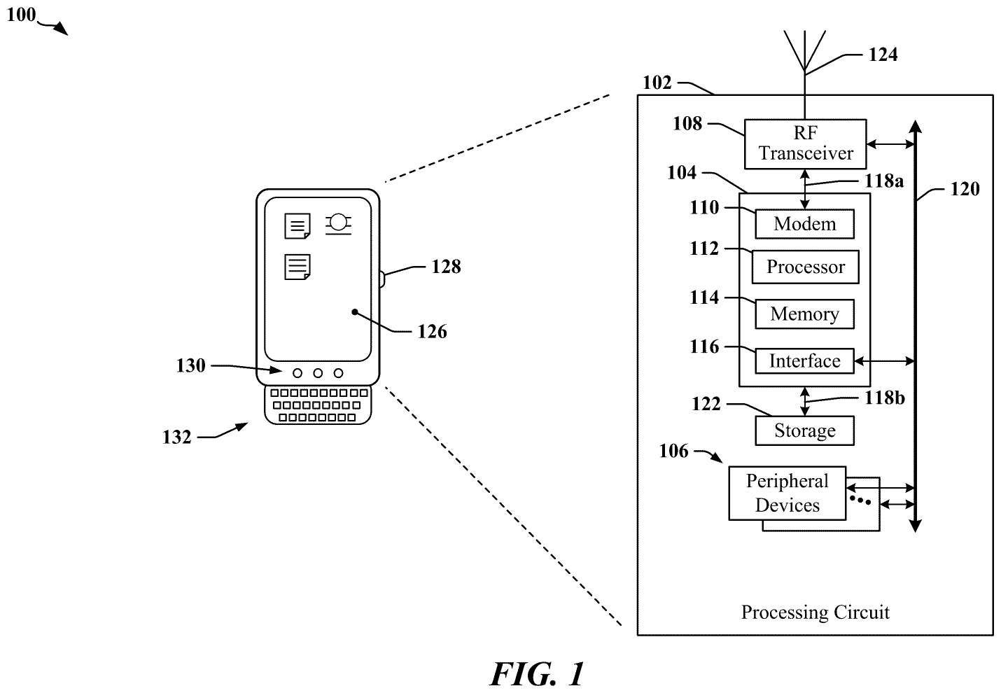

FIG. 1 illustrates an example of an apparatus 100 that employs a data communication bus. The apparatus 100 may include a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable communication between two or more devices 104, 106, and/or 108. In one example, the ASIC 104 may include a bus interface circuit 116 that includes a combination of circuits, counters, timers, control logic and other configurable circuits or modules. In one example, the bus interface circuit 116 may be configured to operate in accordance with standards-defined communication specifications or protocols. The processing circuit 102 may include or control a power management function that configures and manages the operation of the apparatus 100.

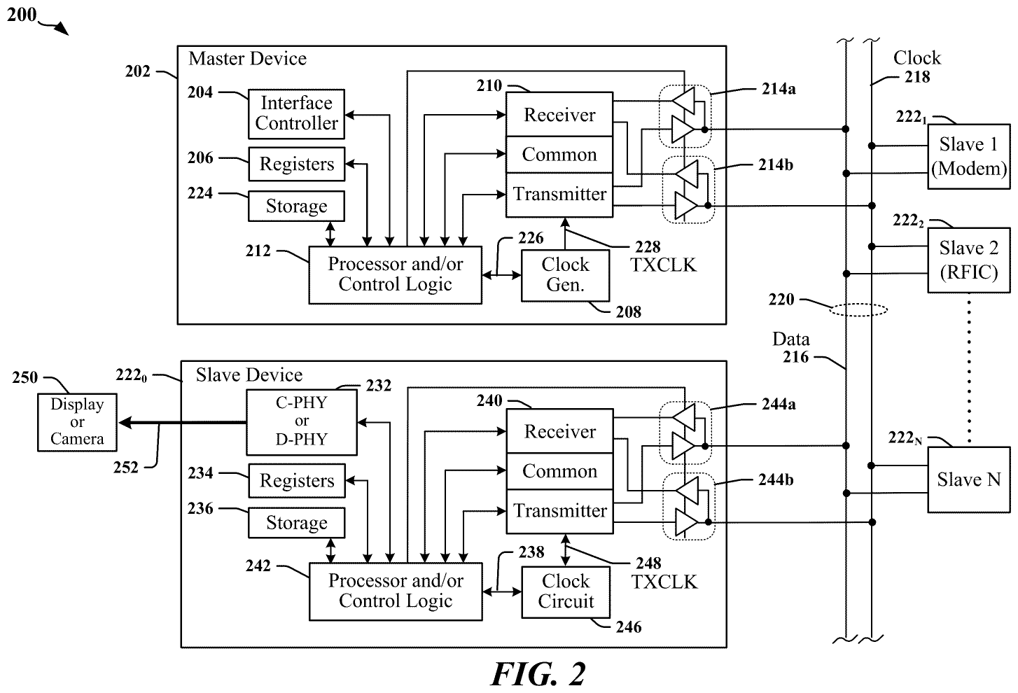

FIG. 2 illustrates a first example of an apparatus 200 employing a data link that may be used to communicatively couple two or more devices. Here, the apparatus 200 includes multiple devices 202, and 2220-222N coupled to a two-wire serial bus 220. The devices 202 and 2220-222N may be implemented in one or more semiconductor IC devices, such as an application processor, SoC or ASIC. In various implementations certain of the devices 202 and 2220-222N may include, support or operate as a modem, a signal processing device, a display driver, a camera, a user interface, a sensor, a sensor controller, a media player, a transceiver, and/or other such components or devices. In some examples, one or more devices 2220-222N may be used to control, manage or monitor a sensor device. Communication between devices 202 and 2220-222N over the serial bus 220 is controlled by a bus master device 202. Certain types of bus can support multiple bus masters 202.

In one example, a bus master device 202 may include an interface controller 204 that may manage access to the serial bus, configure dynamic addresses for slave devices and/or generate a clock signal 228 to be transmitted on a clock line 218 of the serial bus 220. The bus master device 202 may include configuration registers 206 or other storage 224, and other control logic 212 configured to handle protocols and/or higher-level functions. The control logic 212 may include a processing circuit such as a state machine, sequencer, signal processor or general-purpose processor. The bus master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a device 2220 configured to operate as a slave device may provide a control function, module or circuit 232 that includes circuits and modules to support a display, an image sensor, and/or circuits and modules that control and communicate with one or more sensors that measure environmental conditions. In this example, the device 2220 can include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 240 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. In some instances, the clock signal 248 may be derived from a signal received from the clock line 218. Other timing clocks 238 may be used by the control logic 242 and other functions, circuits or modules.

The serial bus 220 may be operated in accordance with RFFE, I2C, I3C, SPMI or other protocols. In some instances, two or more devices 202, 222₀-222_{N} may be configured to operate as a bus master device on the serial bus 220. In some instances, the apparatus 200 includes multiple serial buses 220, 252 that couple two or more of the devices 202, 222₀-222_{N} or one of the devices 202, 222₀-222_{N} and a peripheral device such as a display, imaging device or a Radio-Frequency IC (RFIC). In some examples, one slave device 222₀ is configured to operate as a display or camera coupled to a display or camera 250. The latter slave device 222₀ may include a physical layer circuit 232 that is configured to operate as a C-PHY or D-PHY interface controller that communicates with the display or camera 250 over a serial bus 252 operated in accordance with a C-PHY protocol or a D-PHY protocol.

In certain aspects of this disclosure, systems and apparatus may employ multi-phase data encoding and decoding interface methods for communicating between IC devices. A multi-phase encoder may drive a plurality of conductors (i.e., 3 conductors). Each conductor may be referred to as a wire, although the conductors may include conductive traces on a circuit board or traces or interconnects within a conductive layer of a semiconductor IC device. In one example, a physical layer interface implemented using MIPI Alliance-defined C-PHY technology and protocols (i.e., a C-PHY interface) may be used to connect camera or display to an application processor. The C-PHY interface employs three-phase symbol encoding to transmit data symbols on 3-wire lanes, or “trios” where each trio includes an embedded clock. A trio may be referred to as a lane herein. A multi-lane C-PHY communication channel may be established using multiple trios to carry data exchanged between a pair of devices, where each channel includes one trio that carries a portion of the data, which may be independently encoded in accordance with C-PHY protocols.

The C-PHY interface provides a three-phase encoding scheme for a three-wire system may define three phase states and two polarities, providing 6 states and 5 possible transitions from each state. Deterministic voltage and/or current changes may be detected and decoded to extract data from the three wires.

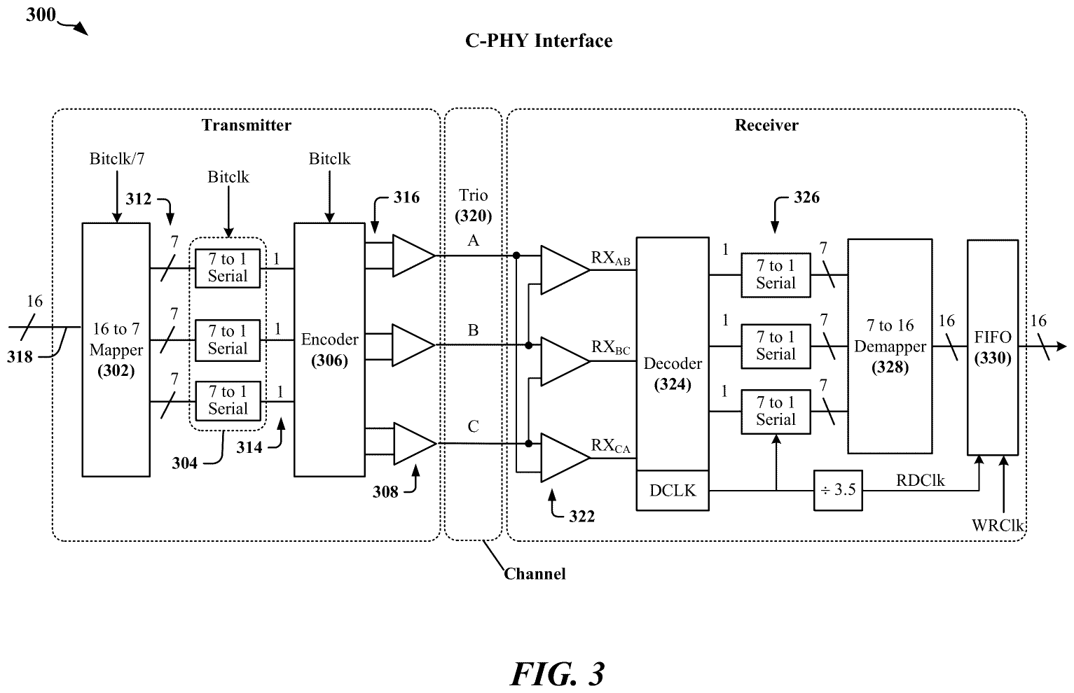

FIG. 3 illustrates a C-PHY interface 300 that may be used to implement certain aspects of the serial bus 252 depicted in FIG. 2. The illustrated example may relate to a three-wire link configured to carry three-phase polarity encoded data in accordance with DSI protocols. The use of 3-phase polarity encoding provides for high-speed data transfer and may consume half or less of the power of other interfaces because fewer than 3 drivers are active at any time in a C-PHY link. The C-PHY interface uses 3-phase polarity encoding to encode multiple bits per symbol transition on the three-wire link. In one example, a combination of three-phase encoding and polarity encoding may be used to support a wide video graphics array (WVGA), 80 frames per second liquid crystal display driver IC without a frame buffer, delivering pixel data for display refresh at 810 Mbps over three or more wires.

In the depicted C-PHY interface 300, three-phase polarity encoding is used to control signaling state of connectors, wires, traces and other interconnects that provide a channel for communication. In the illustrated example, a single unidirectional channel, or lane, is provided using a combination of three wires (the trio 320). Each wire in the trio 320 may be undriven, driven positive, or driven negative in any symbol transmission interval. In some instances, an undriven signal wire of the trio 320 may be in a high-impedance state. In some instances, an undriven signal wire of the trio 320 may be driven or pulled to a voltage level that lies substantially halfway between the positive and negative voltage levels provided on driven signal wires. In some instances, an undriven signal wire of the trio 320 may have no current flowing through it. Drivers 308 coupled to the signal wires of the trio 320 are controlled such that only one wire of the trio 320 is in each of three states (denoted as +1, −1, or 0) in each symbol interval.

In one example, drivers 308 may include unit-level current-mode drivers. In another example, drivers 308 may drive opposite polarity voltages on two signals transmitted on two signal wires of the trio 320 while the third signal wire is at high impedance and/or pulled to ground. For each transmitted symbol interval, at least one signal is in the undriven (0) state, while one signal is driven to the positive (+1 state) and one signal is driven to the negative (−1 state), such that the sum of current flowing to the receiver is always zero. For each symbol, the state of at least one signal wire of the trio 320 is changed from the symbol transmitted in the preceding transmission interval.

In the C-PHY interface 300, a mapper 302 may receive a 16-bit input data word 318, and the mapper 302 may map the input data word 318 to 7 symbols 312 for transmitting sequentially over the signal wires of the trio 320. An M-wire, N-phase encoder 306 configured for three-wire, three-phase encoding receives the 7 symbols 312 produced by the mapper one input symbol 314 at a time and computes the state of each signal wire of the trio 320 for each symbol interval, based on the immediately preceding state of the signal wires of the trio 320. The 7 symbols 312 may be serialized using parallel-to-serial converters 304, for example. The encoder 306 provides control signals 316 to define the outputs of the drivers 308. The encoder 306 selects the states of the signal wires of the trio 320 based on the input symbol 314 and the previous states of signal wires of the trio 320 and may provide control signals 316 to cause the drivers 308 to produce the desired signaling state on the trio 320.

The use of three-wire, three-phase encoding permits several bits to be encoded in a plurality of symbols where the bits per symbol is not an integer. In the example of a three-wire, three-phase system, there are 3 available combinations of 2 wires, which may be driven simultaneously, and 2 possible combinations of polarity on the simultaneously driven pair of wires, yielding 6 possible states. Since each transition occurs from a current state, 5 of the 6 states are available at every transition. With 5 states, log₂(5)≅2.32 bits may be encoded per symbol transition. Accordingly, a mapper may accept a 16-bit word and convert it to 7 symbols because 7 symbols carrying 2.32 bits per symbol can encode 16.24 bits. In other words, a combination of seven symbols that encodes five states has 5⁷ (78,125) permutations. Accordingly, the 7 symbols may be used to encode the 2¹⁶ (65,536) permutations of 16 bits.

The C-PHY interface 300 includes a receiver that includes comparators 322 and a decoder 324 that are configured to provide a digital representation of the state of each of three signal wires of the trio 320, as well as the change in the state of the three signal wires compared to the state transmitted in the previous symbol period. Seven consecutive states are assembled by serial-to-parallel convertors 326 and used to produce a set of 7 symbols to be processed by a demapper 328 to obtain 16 bits of data that may be buffered in a first-in-first-out (FIFO) storage device 330, which may be implemented using registers, for example.

According to certain aspects disclosed herein, systems and apparatus may employ some combination of differential and single-ended encoding for communicating between IC devices. In one example, the MIPI Alliance-defined “D-PHY” physical layer interface technology may be used to connect camera and display devices to an application processor. The D-PHY interface can switch between a differential (High-Speed) mode and a single-ended low-power (LP) mode in real time as needed to facilitate the transfer of large amounts of data or to conserve power and prolong battery life. The D-PHY interface is capable of operating in simplex or duplex configuration with single data lane or multiple data lanes with a unidirectional (Master to Slave) clock lane. In one example, a data lane is implemented using a single wire. Single-wire lanes may be used at lower data rates that are used to generate data signals that can be transmitted with limited losses such that a receiver can readily decode the data carried over the data lane. Two-wire lanes that carry differentially encoded clock and data signals provide common mode rejection of electromagnetic interference and can limit attenuation of higher frequency components in signals transmitted over the lanes.

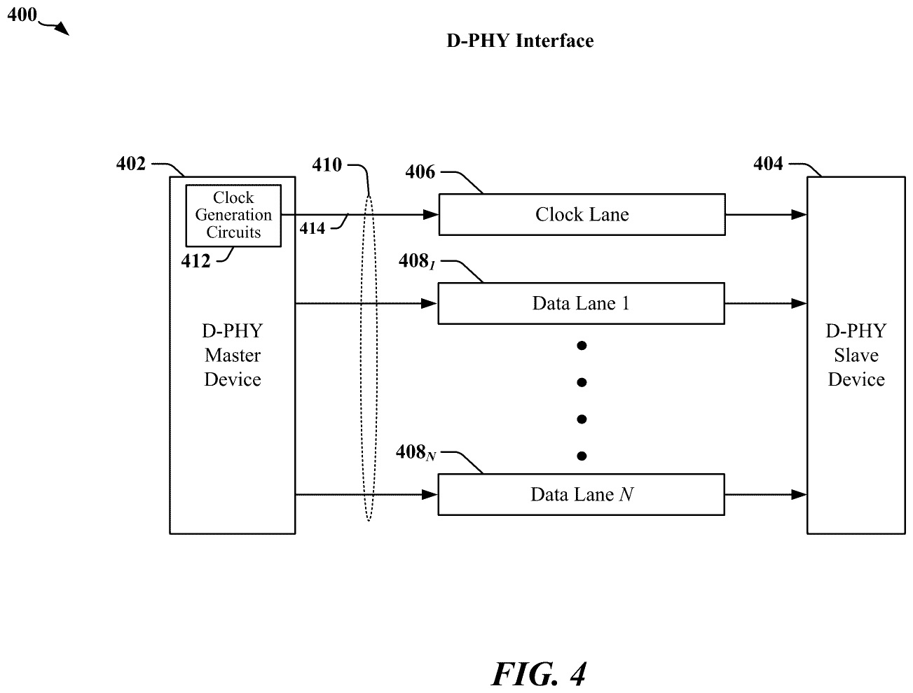

FIG. 4 illustrates a generalized example of a D-PHY interface 400 that includes a bus master device 402 and a slave device 404 coupled using a set of wires 410 that are used to provide a clock lane 406 and one or more data lanes 408₁-408_{N}. For high-speed operation, the clock lane 406 and the data lanes 408₁-408_{N} may each be provided using a pair of wires to carry a differential signal. In one example, the slave device 404 is provided in a display driver IC (DDIC) associated with a display panel, and the bus master device 402 is included in an application processor or provided by another processing circuit.

In the illustrated example, a clock signal is transmitted on a clock lane 406 and data is transmitted in one or more data lanes 408₁-408_{N}. The bus master device 402 includes clock generation circuits 412 that can be configured to generate a clock signal 414 that is transmitted over the clock lane 406 to control transmissions over the data lanes 408₁-408_{N}: The frequency of the clock signal 414 may be configured during system initialization or configuration and/or may be dynamically configured based on mode of operation of the D-PHY interface 400, application needs, volumes of data to be transferred and power conservation needs. The number of data lanes 408₁-408_{N} that are provided or that are active in a device may be configured during system initialization or configuration and/or may be dynamically configured based on mode of operation of the D-PHY interface 400, application needs, volumes of data to be transferred and power conservation needs.

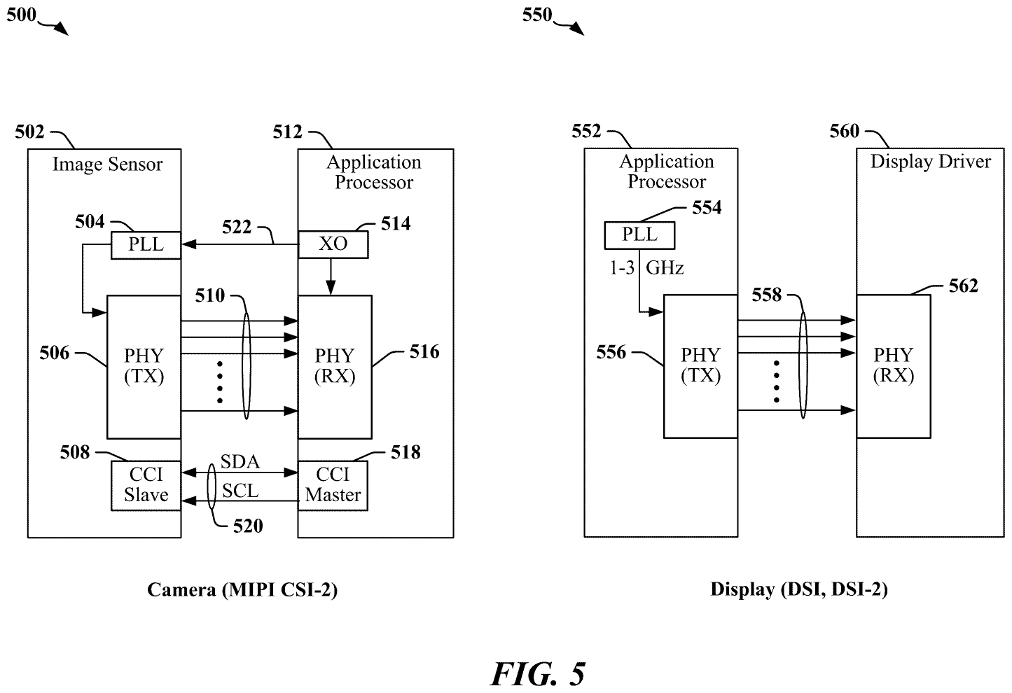

FIG. 5 illustrates certain interface configurations associated with a camera subsystem 500 and a display subsystem 550 that may be deployed within a mobile communication device, for example. The camera subsystem 500 may include a CSI-2 defined communication link between an image sensor 502 and an application processor 512. The communication link may include a high-data rate data transfer link 510 used by the image sensor 502 to transmit image data to the application processor 512 using a transmitter 506. The high-data rate data transfer link 510 may be configured and operated according to D-PHY or C-PHY protocols. The application processor 512 may include a crystal oscillator (XO 514) or other clock source to generate a clock signal 522 that controls the operation of the transmitter 506. The clock signal 522 may be processed by a phase-locked loop (PLL) 504 in the image sensor 502. In some instances, the clock signal 522 may also be used by the D-PHY or C-PHY receiver 516 in the application processor 512. The communication link may include a Camera Control Interface (CCI), which is similar in nature to the Inter-Integrated Circuit (I2C) interface. The CCI bus may include Serial Clock (SCL) line that carries a clock signal and a Serial Data (SDA) line that carries data. The CCI link 520 may be bidirectional and may operate at a lower data rate than the high-data rate data transfer link 510. The CCI link 520 may be used by the application processor 512 to transmit control and data information to the image sensor 502 and to receive control and configuration information from the image sensor 502. The application processor 512 may include a CCI bus master 518 and the image sensor 502 may include a CCI slave 508.

The display subsystem 550 may include a unidirectional data link 558 that can be configured and operated according to D-PHY or C-PHY protocols. In the application processor 552, a clock source such as the PLL 554 may be used to generate a bit clock signal used by a D-PHY or C-PHY receiver 556 to control transmissions on the data link 558. At the display driver 560, a D-PHY or C-PHY receiver 562 may extract embedded clock information from sequences of symbols transmitted on the data link, or from a clock lane provided in the data link 558.

Certain aspects disclosed herein relate to systems, apparatus and methods that support a broad range of interface protocols, and that can operate using different physical media. As shown in FIG. 5, for example, the camera subsystem 500 and/or display subsystem 550 may communicate high data rate information using D-PHY or C-PHY protocols. In some configurations, the camera subsystem 500 and/or display subsystem 550 may communicate using a reverse channel (e.g., the CCI link 520) for configuration of an image sensor 502 or other device. In some instances, a low-power mode of operation may be defined for links that use either D-PHY or C-PHY protocols.

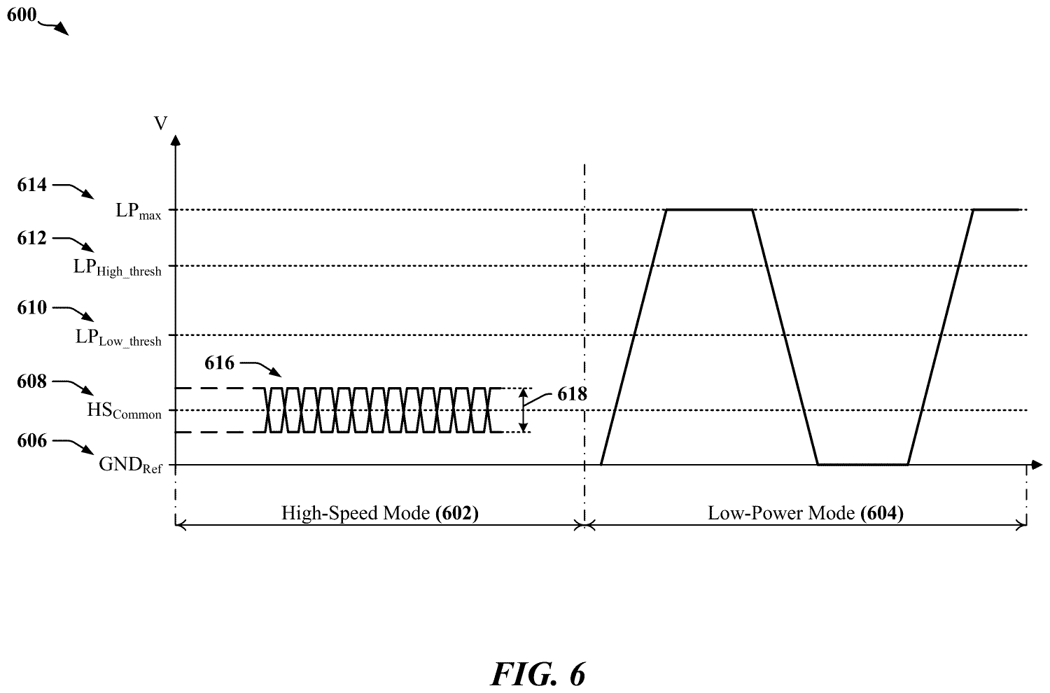

FIG. 6 is a timing diagram illustrating certain features of waveforms 600 that relate to modes of operation defined by C-PHY and D-PHY protocols. For example, the waveforms 600 illustrate relative differences in voltage levels of signals transmitted in a high-speed (HS) communication mode and a low-power (LP) communication mode. The high-speed communication mode may be referred to as the high-speed mode 602 herein and the low-power communication mode may be referred to as the low-power mode 604 herein. Data is transmitted at a significantly lower rate in the low-power mode 604 than in the high-speed mode 602. The high-speed mode 602 and the low-power mode 604 operate at different voltage levels and voltage ranges, and may transmit signals using at least some of the same wires of a serial bus.

In the high-speed mode 602, signals are centered on a high-speed common (HS_{Common}) voltage level 608, which can be offset from a reference ground voltage level 606. Signals in the high-speed mode 602 have a voltage range 618 that ensures that high-speed signals 616 do not exceed a logic low threshold voltage level (LP_{Low_thresh}) 610, which defines the upper limit for logic low in the low-power mode 604. In one example, the HS_{Common} voltage level 608 may be nominally defined to be 200 millivolts (mV), and the voltage range 618 for high-speed signals may be nominally defined to be 200 mV.

In the low-power mode 604, signals switch between a maximum low-power (LPₘₐₓ) voltage level 614 and the reference ground voltage level 606. The logic low threshold voltage level LP_{Low_thresh} 610 and the logic high threshold voltage level (LP_{High_thresh}) 612 define the switching voltage levels for high-to-low transitions and low-to high transitions, respectively. In one example, the maximum low-power (LPₘₐₓ) voltage level 614 may be nominally defined at 1.2 Volts (V). Receivers in conventional C-PHY and D-PHY interfaces can use voltage level detectors to switch between high-speed and low-power modes of operation.

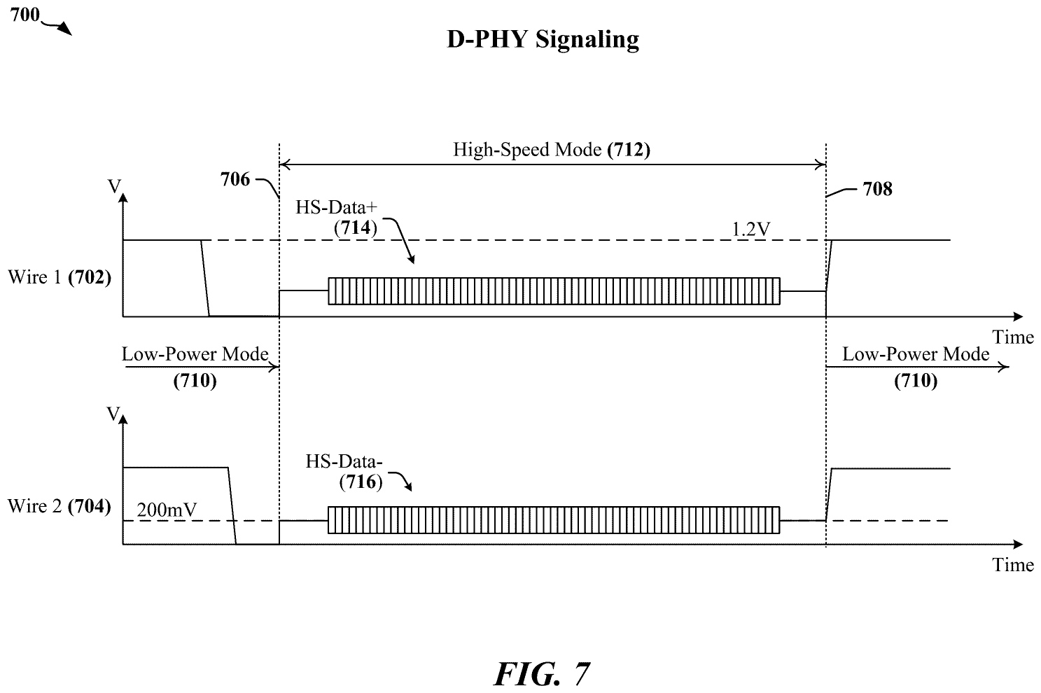

FIG. 7 illustrates certain aspects of signaling 700 that may be observed in a D-PHY interface when transitions between communication modes are occurring. The illustrated example relates to wires 702, 704 that are configured as data lanes in a communication link operated in accordance with D-PHY protocols. The D-PHY interface may be configured to operate in a low-power mode 710 and/or in a high-speed mode 712. In the illustrated example, the high-speed mode 712 starts at a first point in time 706 and ends at a second point in time 708.

In the low-power mode 710, a first wire carries data signals at a relatively low data rate and with a voltage level swing of approximately 1.2 volts. In the high-speed mode 712, the first wire 702 and second wire 704 carry a low-voltage differential signal that can have a data rate that is orders of magnitude faster than the data rate of the low-power mode 710. For example, the low-power mode 710 may support data rates up to 10 megabits per second (Mbps) while the high-speed mode 712 may support data rates that lie between 80 Mbps and 4.5 gigabits per second (Gbps). The positive version 714 of the differential signal may be carried on the first wire 702, while the negative version 716 of the differential signal is carried on the second wire 704, in the high-speed mode 712. The differential signal may have a relatively low amplitude voltage swing, which in one example may be approximately 200 millivolts (mV).

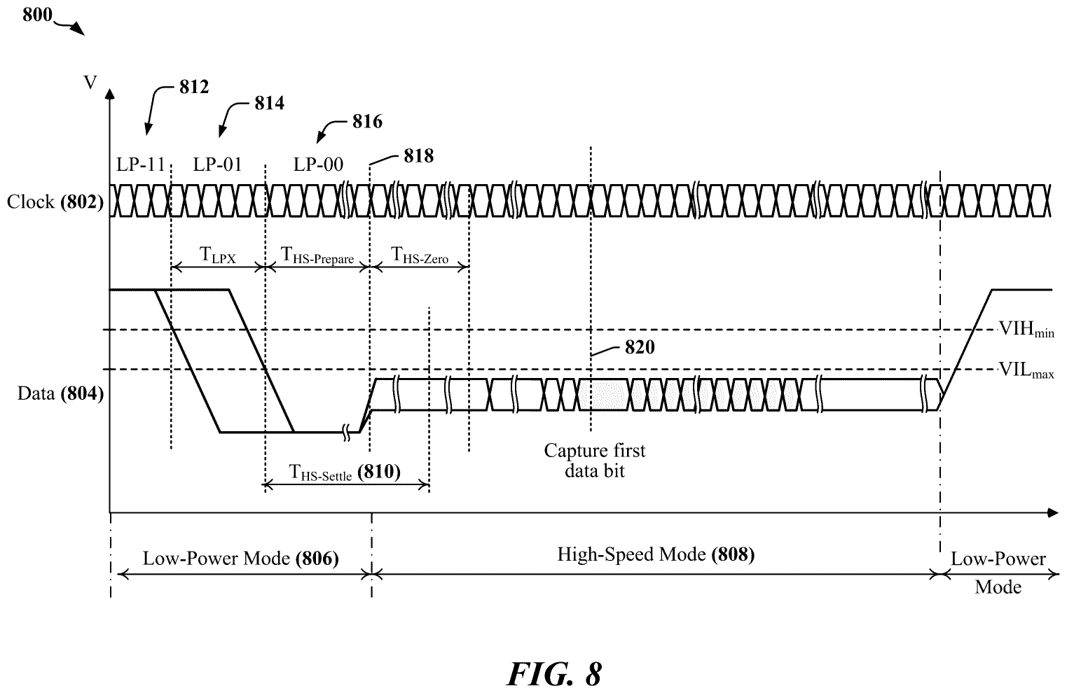

FIG. 8 illustrates transmission latency associated with transitions between communication modes in the example of a D-PHY interface. The timing diagram 800 relates to the commencement of high-speed mode communication in the D-PHY interface and illustrates timing of signals transmitted on the clock lane 802 and a data lane 804 in high-speed mode 808 and in low-power mode 806. The D-PHY interface is initially configured for the low-power mode 806. A change from low-power mode 806 to high-speed mode 808 is indicated by the transmission of a sequence of three states in low-power mode 806, including the LP-11 state 812, the LP-01 state 814 and the LP-00 state 816. The LP-01 state 814 and the LP-00 state 816 are transmitted after a transition on the clock lane 802 to a high-speed clock signal. The high-speed mode 808 may commence at a point in time 818 after transmission of the sequence of three states.

D-PHY specifications define timing limits and tolerances for a settle period 810 that follows the LP-11 state 812, the LP-01 state 814 and the LP-00 state 816. In some instances, the settle period 810 may be considered to include the LP-00 state 816. A D-PHY receiver is expected to be able to capture data from the signal transmitted on the data lane 804 after the settle period 810. The receiver can capture data from the data lane 804 at a point in time 820 after it has enabled its HS line receiver circuits and has aligned its sample clock with the data signal received from the data lane 804 and/or with the high-speed clock signal transmitted on the clock lane 802.

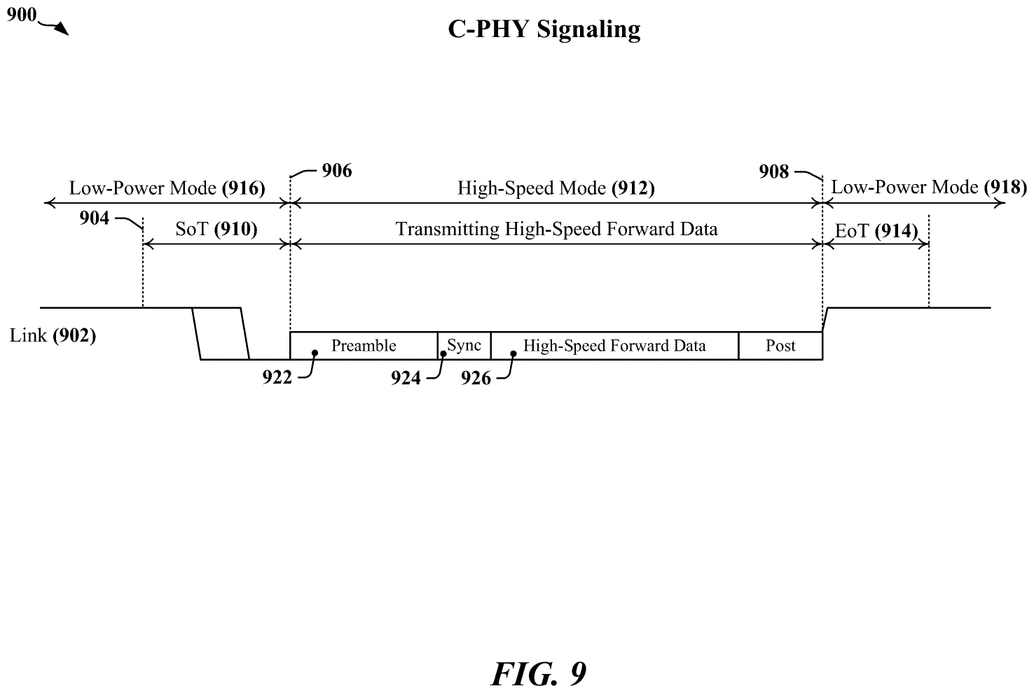

FIG. 9 is a timing diagram 900 that illustrates transmission latency associated with transitions between communication modes in the example of a C-PHY interface. Transmission latency may include the time required to terminate a transaction in process on the serial bus, driver reconfigurations from high-speed mode to low-power mode and from low-power mode to high-speed mode and the time required to transmit high-speed signaling that configures and calibrates the interface for high-speed mode.

The C-PHY interface is initially configured for a low-power mode 916. Commencing at a first point in time 904, the SoT sequence 910 is transmitted on the link 902 to switch the C-PHY interface to a high-speed mode 912. High-speed transmission begins at a second point in time 906. Commencing at a third point in time 908, an EoT sequence 914 is transmitted to return the C-PHY interface to a low-power mode 918. A receiver may determine that a return of the C-PHY interface to a low-power mode 918 is desired based on signaling received at the higher voltage levels used in low-power modes. In some implementations, the receiver resets its physical layer circuits when it detects the LP-11 state 812 (see FIG. 8) on the serial bus.

According to C-PHY protocols, preambles 922 and synchronization patterns 924 are transmitted before the high-speed data payload 926 is transmitted. The preambles 922 may be used to calibrate receiver circuits. In one example, a receiver uses one of the preambles 922 to calibrate equalizing circuits. In another example, the receiver uses one of the preambles 922 to calibrate clock generation circuits. Synchronization patterns 924 may be used to ensure that a receiver reliably recognizes the start of the high-speed data payload 926. Accordingly, transitions from low-power mode 916 to high-speed mode 912 can introduce significant transmission latency.

Nominally, transmission latency has minimal effect on display interfaces operated in accordance with DSI or DSI-2 protocols and specifications. In some examples, display data for a complete display frame can be transmitted in one high-speed transaction. In other examples, the display data for the display frame can be transmitted in a small number of high-speed transactions. In these examples, the time expended while transitioning between low-power (LP) and high-speed (HS) modes is averaged over many lines of the frame and has minimal effect on the efficiency of the D-PHY or C-PHY interface. The efficiency and, consequently, the available bandwidth of the D-PHY or C-PHY interface can be significantly reduced when transmission errors occur frequently. An error in transmission over the serial bus generally results in loss of synchronization that causes the D-PHY or C-PHY interface to drop out of high-speed mode in order to resynchronize the receiver after an error is detected. The transmitter may be notified of the occurrence of an error in transmission by a message transmitted over a control interface operated using CCI, I2C, I3C, SPMI, RFFE or other serial protocols. The delay in processing the message, particularly when the control interface is provided by a shared bus, can significantly increase display interface latency associated with transmission errors.

Transmission errors may be caused by electrostatic discharge (ESD) events, electromagnetic interference (EMI) and mechanical impacts affecting connectors and other components, for example. Advances in semiconductor fabrication technologies tend to produce smaller devices that may be more susceptible to ESD and mechanical stresses, strains and impacts. The deployment of newer generations of radio access technologies can increase the EMI experienced by circuits in a wireless communication device. For example, the implementation and deployment of fifth generation technologies and the use of millimeter wavelengths has increased the modes of EMI that can affect circuits in wireless communication devices.

Increased transmission errors can lead to corruption of display content in several lines or over the whole display frame. Conventional methods for managing display system transmission errors and for recovering from these errors are fraught with unintended negative consequences that can limit the functionality of the display system.

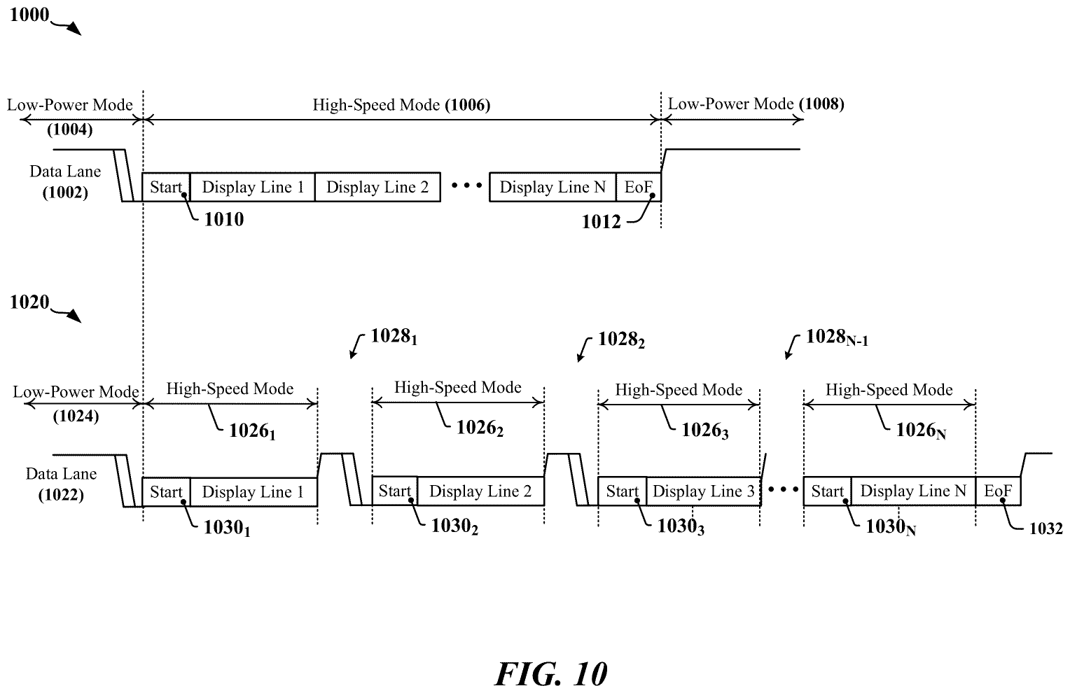

FIG. 10 illustrates one solution that is often used to combat the effects of transmission errors in a display interface. The first waveform 1000 illustrates one data lane 1002 during an errorless transmission of display data for a complete display frame. In the first waveform 1000, frame transmission is accomplished in one high-speed transaction. The display interface is initially in a low-power mode 1004 and transitions to high-speed mode 1006 during which data for a full display frame is transmitted before an end-of-frame sequence (EoF 1012) is transmitted and the display interface is returned to low-power mode 1008. A single start sequence 1010 is configured according to the display interface protocol in use. The start sequence 1010 is transmitted to calibrate and/or synchronize the receiver at the beginning of each display frame.

The second waveform 1020 illustrates one data lane 1022 during a transmission of display data for a complete display frame when the data lane 1022 is susceptible to a high error rate. The error rate may be considered high when the number of display lines (also known as pixel lines) affected by errors exceeds a threshold level. The high error rate threshold level may be determined based on display configuration, resolution, available bandwidth or capacity of the serial link. In one example, a high error rate may be deemed to have occurred when more than 5% of the display lines are affected by transmission errors on the serial link. In other examples, an application may be able to tolerate error rates that affect up to 50% of the display line including, for example, when the display is static or changes slowly. In the second waveform 1020, frame transmission is accomplished using multiple high-speed transactions. The display interface is initially in a low-power mode 1024 and transitions to high-speed mode 1026₁ for transmission of the data associated with the first display line. The display interface is then returned to low-power mode 1028₁. Data transmission for each display line includes transitioning the display interface transitions to high-speed mode 1026_{1-N}, transmitting start sequences 1030₁-1030_{N} and then transmitting data for the current display line and returning to low-power mode 1028₁-_{N-1}. The start sequences 1030₁-1030_{N} may be configured according to the display interface protocol used to control communication. The start sequences 1030₁-1030_{N} are used for calibrating and/or synchronizing the receiver at the beginning of each display line. An end-of-frame sequence (EoF 1032) is transmitted after data for all display lines have been transmitted.

The solution illustrated in FIG. 10 forcedly inserts LP-11 states (see the LP-11 state 812 in FIG. 8) at 1.2 volts before transmitting data for each display line (pixel line) in high-speed signals at 200 mV. The transmission of an LP-11 state at the beginning of each display line transmission guarantees that prior signaling errors are cleared and ensures quick error recovery by eliminating the need for monitoring for error notifications from the display panel. Provision of an LP-11 state for each display line can minimize the error recovery response time with little or no visual loss. It can be expected that losses due to transmission errors will be imperceptible to a user of the display panel when any errors affect only one display line. The inserted LP-11 states prevent continuation of the effects of any transmission errors that affected the preceding display line. Errors occurring on a display serial interface generally affect all of the data transmitted after the bit affected by the error. Moreover, the errors can cause a finite state machine in the bus interface of a DDIC to become unstable. The inserted LP-11 states operate to return the finite state machine to stability.

The approach of forcedly inserting LP-11 states is widely used, but is accompanied by large power and time costs associated with the additional transmissions during transitions between high-speed and low-power modes. The additional transmissions can limit the available data throughput over the display system interface and can consequently limit the display resolution and frames-per-second (FPS) that can be supported by a DDIC, even as demand for increased resolution and display responsiveness increases.

The insertion of LP-11 states and associated start sequences 1030₁-1030_{N} can add a 2 microsecond (2 μs) overhead for transmission of data for each display line. A transmission time of 2.4 us is available for transmitting data for a display line in a display that is refreshed at 120 FPS and provides a resolution of 1440×3200 pixels. When an LP-11 state is provided for each display line, only 0.4 us remains for data transmission, and a clock rate in excess of at least 20 GHz would be required for a display that supports the 1440×3200 resolution and 120 FPS refresh rate. The use of inserted LP-11 states for each display line may be considered impractical for high resolution or high-FPS displays and usable only with low resolution and low FPS displays.

Power increases due to the forcible insertion of LP-11 states can arise from increased system clock rates. The insertion of LP-11 states for every line generally requires an increase in system clock rates in order to transmit frame data without altering the number of pixels per frame or the FPS. Many DDICs are unable to increase clock rates sufficiently. For example, it is fairly common for a display panel to include a DDIC that supports a maximum DSI bit clock of 1 GHz for C-PHY and 1.2 GHz for D-PHY. At these clock rates, the bandwidth margins render it impractical to support forced LP-11 insertion.

A compromise solution in which LP-11 states are inserted for groups of display lines increases power consumption and enables transmission errors to affect many more pixels and lines of pixels. For example, insertion of LP-11 states after every 10 display lines can delay error correction such that 9 lines of pixels are corrupted after a transmission error occurs, and insertion of LP-11 states after every 20 display lines can delay error correction such that 19 lines of pixels are corrupted after a transmission error occurs.

Certain aspects of this disclosure relate to error recovery in a high-speed serial bus interface that enables a receiving device to signal a transmitting device when an error in transmission is detected. The transmitting device may immediately terminate transmission upon detecting an error signal, reset the interface and restart transmission. In some implementations, the effect of the error in transmission is limited to a single display line. In some implementations, the effect of the error in transmission is limited to a few pixels within a single display line. Certain aspects of this disclosure relate to an error handling technique that results in a minimal increase in power consumption with little or no visual loss, and that is characterized by an error recovery response time that is less than the response time associated with schemes that use forced LP-11 insertion.

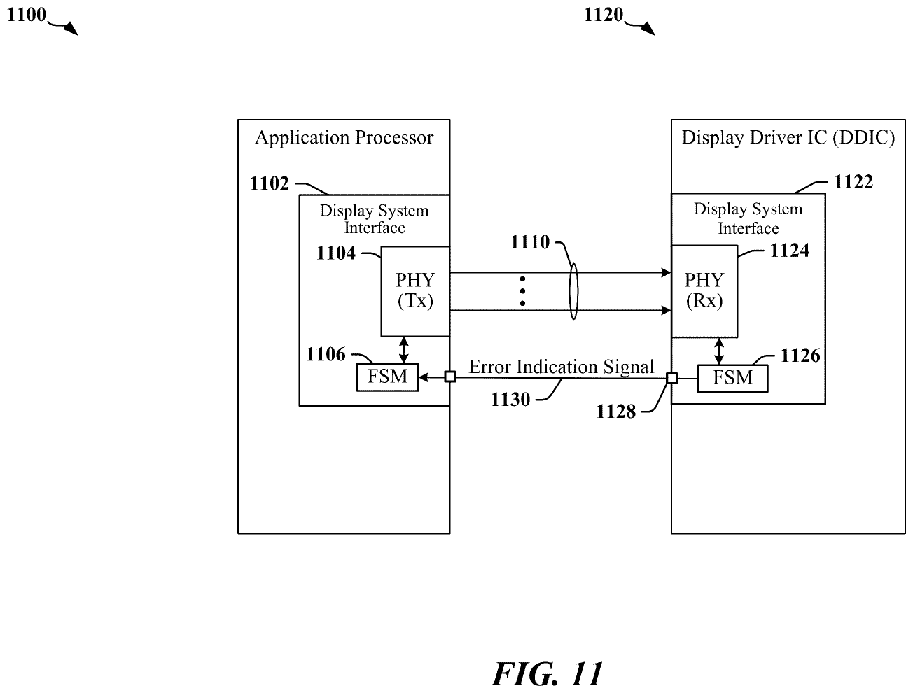

FIG. 11 illustrates certain aspects of a display system adapted or configured in accordance with certain aspects of this disclosure. In the illustrated example, a unidirectional data link 1110 couples an application processor 1100 to a DDIC 1120. The application processor 1100 has a display system interface 1102 that includes physical interface circuits 1104 configured for transmitting data over the data link 1110 in accordance with a D-PHY or C-PHY protocol. The DDIC 1120 has a display system interface 1122 that includes physical interface circuits 1124 configured for receiving data from the data link 1110 in accordance with a D-PHY or C-PHY protocol. The DDIC 1120 has a finite state machine 1126, protocol controller or general purpose processing circuit that can be configured to respond to commands conveyed by signals received from the data link 1110, decode data from the signals received from the data link 1110 and detect transmission errors. The transmission errors may be detected as decoding errors. For example, an error in transmission may cause a decoder to generate an invalid sequence of decoded bits. A parity checker or other redundancy checker may flag an error in a received block of data. The block of data may be a byte, word, a data element representing a single pixel, a data element representing the pixels in a portion of a display line or a block of data representing a complete display line.

The finite state machine 1126 may be configured to signal the occurrence of a transmission error by driving a general purpose input/output (GPIO) pad 1128 or otherwise causing a change in signaling state of an error indication signal 1130 that is transmitted by the DDIC 1120 to the application processor 1100. In the illustrated example, the display system interface 1102 in the application processor 1100 includes a finite state machine 1106 that receives the error indication signal 1130. The finite state machine 1106 may be configured to manage and control communication from the application processor 1100 to the DDIC 1120. In one example, the finite state machine 1106 may be configured to determine when display data is available for transmission to the DDIC 1120, format the data for transmission in accordance with a D-PHY or C-PHY protocol, provide transmission clock signals, and generate control signaling used to determine a mode of operation of the data link 1110. The finite state machine 1106 may be further configured to activate line drivers and cause the physical interface circuits 1104 to transmit start sequences and end sequences over the data link 1110, including synchronization sequences and preambles where required by protocol. The finite state machine 1106 may be further configured to monitor and control transmission of data payloads over the data link 1110.

In the illustrated example, the state of the finite state machine 1106 may change in response to transitions detected in the error indication signal 1130. The finite state machine 1106 may enable normal communication when the error indication signal 1130 is in a first, inactive signaling state. The finite state machine 1106 may be configured to halt communication when the error indication signal 1130 is in a second, active signaling state. When halting communication, the finite state machine 1106 may cause an LP-11 state to be inserted on the data link 1110. The LP-11 state causes the finite state machine 1126 in the DDIC 1120 to be reset and to enter a state in which it is awaiting the start of a new transmission.

In some implementations, the GPIO pad 1128 in the DDIC 1120 may be selected from a group of otherwise unassigned pads and allocated for forwarding the error indication signal 1130. In some implementations, the GPIO pad 1128 may be used for asserting an interrupt service request (ISR) and the GPIO pad 1128 may be repurposed, shared or otherwise allocated for forwarding the error indication signal 1130.

At the application processor 1100, the error indication signal 1130 may be provided to an interrupt service request input that ultimately interrupts and resets the operation of the finite state machine 1106. In one example, the error indication signal 1130 may be provided to an interrupt service request input of the finite state machine 1106. In another example, the error indication signal 1130 may be provided to an interrupt service request input of another processing circuit that can control or message the finite state machine 1106. In another example, the error indication signal 1130 may be provided to a reset input of the finite state machine 1106 that causes the finite state machine 1106 to be restarted. In another example, the finite state machine 1106 may monitor the error indication signal 1130 as a parameter that indicates when the transmission of display data is to be halted, reset and/or restarted.

In response to an active signaling state on the error indication signal 1130, the finite state machine 1106 may stop a current high-speed transmission and assert LP-11 state on the data link 1110. The finite state machine 1126 in the DDIC 1120 may de-assert the error indication signal 1130 by driving the GPIO pad 1128 to an inactive state after the physical interface circuits 1124 in the DDIC 1120 have recovered from the error and/or have been reset.

In some implementations, the finite state machine 1106 in the application processor 1100 is halted when the error indication signal 1130 is asserted or otherwise activated. The finite state machine 1106 may resume a high-speed transmission when the error indication signal 1130 is de-asserted or otherwise inactivated. In one example, the finite state machine 1106 resumes the high-speed transmission at the next display line. In another example, the finite state machine 1106 resumes the high-speed transmission by retransmitting all of the data for the display line affected by the transmission error. In another example, the finite state machine 1106 resumes the high-speed transmission by retransmitting some portion of the data for the display line affected by the transmission error, including data that was corrupted due to the transmission error.

In some instances, the finite state machine 1126 in the DDIC 1120 may not de-assert the error indication signal 1130 in a timely manner. In these instances, the finite state machine 1106 in the application processor 1100 may wait for a period of time configured or defined by application, protocol or during system configuration. In some examples, the period of time may be measured by a timer or counter. A failure to de-assert the error indication signal 1130 within the configured period of time can result in a time out occurring. When the finite state machine 1106 in the application processor 1100 determines that a time out has occurred, the application processor 1100 and/or the finite state machine 1106 may initiate a reset of the DDIC 1120 and/or its associated display panel.

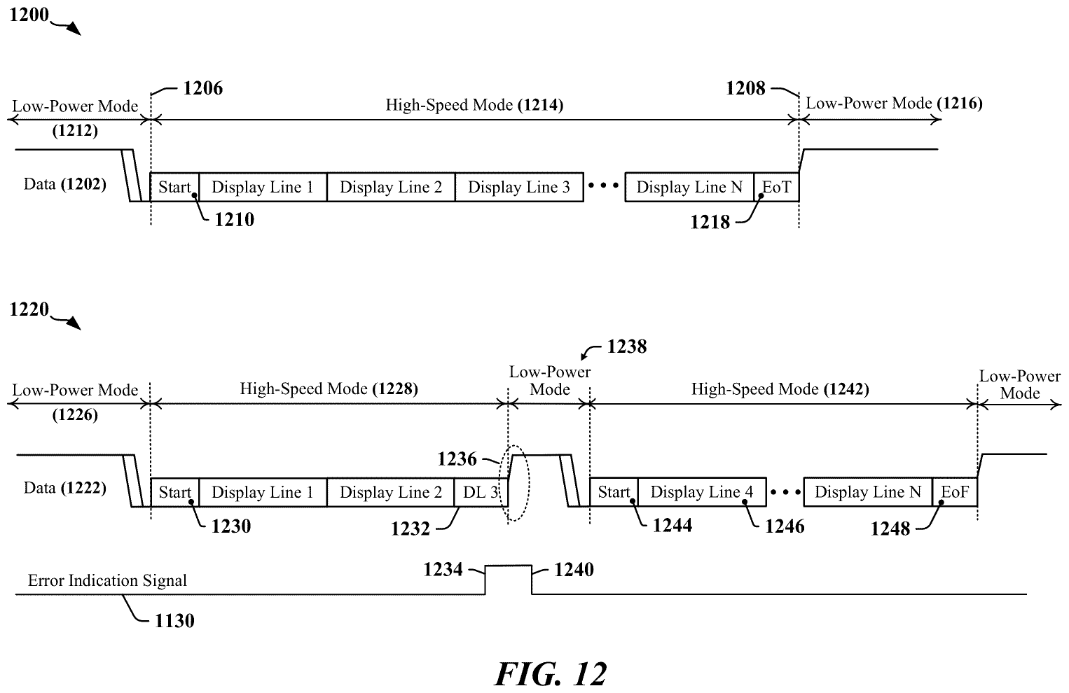

FIG. 12 illustrates certain aspects of the operation of the display system illustrated in FIG. 11. A first waveform 1200 illustrates signaling on one data lane 1202 during an errorless transmission of display data for a complete display frame. In the first waveform 1200, frame transmission is accomplished in one high-speed transaction. The display interface is initially in a low-power mode 1212 and transitions at a first point in time 1206 to high-speed mode 1214 during which data for a full display frame is transmitted before an end-of-frame sequence (EoF 1218) is transmitted and the display interface is returned to low-power mode 1216 at a second point in time 1208. A single start sequence 1210 is configured according to the display interface protocol and is transmitted to calibrate and/or synchronize the receiver at the beginning of each display frame.

The second waveform 1220 illustrates one data lane 1222 during a transmission of display data for a complete display frame when the data lane 1222 is affected by a transmission error. The display interface is initially in a low-power mode 1226 and transitions to high-speed mode 1228. A start sequence 1230 is provided before transmission of the data begins. In the illustrated example, a transmission error occurs or is detected during transmission 1232 of data for the third display line. The DDIC 1120 drives the error indication signal 1130 high providing a rising edge 1234 in the error indication signal 1130. The finite state machine 1106 in the application processor 1100 detects the rising edge 1234 or detects the active state of the error indication signal 1130 and inserts LP-11 signaling 1236 on the data lane 1222. The data lane 1222 enters low-power mode 1238 and the finite state machine 1126 in the DDIC 1120 is reset, The DDIC performs error recovery and may de-assert the error indication signal 1130 when ready to resume communication. The de-assertion of the error indication signal 1130 is indicated by the falling edge 1240 in the error indication signal 1130. The finite state machine 1106 in the application processor 1100 detects the falling edge 1240 or the inactive state of the error indication signal 1130 and resumes transmission by initiating high-speed mode 1242.

In the illustrated example, the finite state machine 1106 in the application processor 1100 provides a start sequence 1244 and begins transmitting data for the fourth display line 1246. In other examples, the finite state machine 1106 resumes the high-speed transmission by retransmitting all of the data for the third display line, which was directly affected by the transmission error. In another example, the finite state machine 1106 resumes the high-speed transmission by retransmitting some portion of the data for the display line affected by the transmission error, including data that was corrupted due to the transmission error.

The start sequences 1210, 1230, 1244 may be configured according to the display interface protocol and are used for calibrating and/or synchronizing the receiver at the beginning of high-speed mode. An end-of-frame sequence (EoF 1248) is transmitted after data for all display lines have been transmitted. The insertion of the LP-11 signaling 1236 when the error indication signal 1130 is asserted clears the effects of the transmission error in the DDIC 1120. It can be expected that losses due to transmission errors will be imperceptible to a user of the display panel when errors are signaled upon detection. The inserted LP-11 signaling 1236 prevents continuation of the effects of any transmission errors that affected the preceding display line. Errors occurring on a display serial interface generally affect all of the data transmitted after the bit affected by the error until the physical interface circuits 1124 in the DDIC 1120 have been reset. Moreover, the use of the error indication signal 1130 can prevent the finite state machine 1126 in the bus interface of the DDIC 1120 from becoming unstable and, in any case, the inserted LP-11 signaling 1236 operate to return the finite state machine to stability.

According to certain aspects of the disclosure, the application processor 1100 may treat an assertion of the error indication signal 1130 as a request from the DDIC 1120 to stop high-speed communication. A timeout mechanism or hardware temporal filter may be used to limit the time in which high-speed transmissions are halted. In some instances, the error indication signal 1130 may be received by a processing circuit that can control the physical interface circuits 1104 and/or the finite state machine 1106 in the application processor 1100. The processing circuit may implement a procedure that includes causing the physical interface circuits 1104 and/or the finite state machine 1106 to halt high-speed data transmissions to the DDIC 1120. In some instances, the processing circuit may issue one or more commands or messages provided to the physical interface circuits 1104 and/or the finite state machine 1106 in order to halt high-speed data transmissions to the DDIC 1120. The commands may cause the physical interface circuits 1104 to provide the inserted LP-11 signaling 1236. The processing circuit may be configured to control the period during which high-speed data transmissions are halted based on parameters determined by or derived from quality of service (QOS) configurations managed, implemented or enforced by the processing circuit.

A display system interface provided in accordance with certain aspects of this disclosure may improve resilience of a data link to transmission errors and optimize error correction times without increasing the clock rate used to control transmissions over the data link.

### Examples of Processing Circuits and Methods

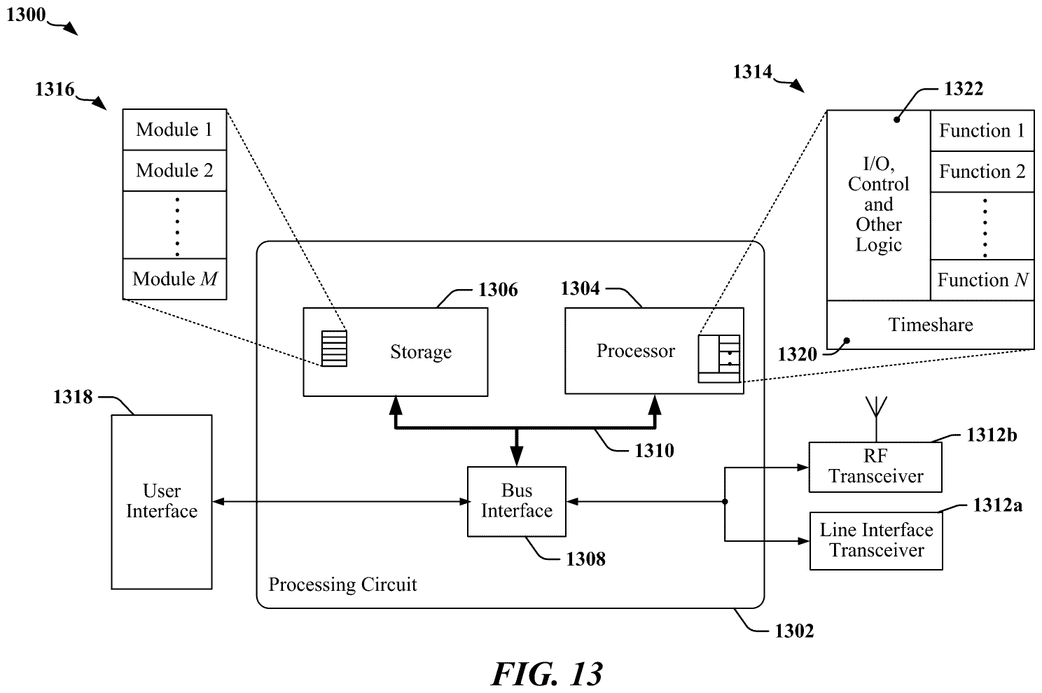

FIG. 13 is a diagram illustrating an example of a hardware implementation for an apparatus 1300. In some examples, the apparatus 1300 may perform one or more functions disclosed herein. In accordance with various aspects of the disclosure, an element, or any portion of an element, or any combination of elements as disclosed herein may be implemented using a processing circuit 1302. The processing circuit 1302 may include one or more processors 1304 that are controlled by some combination of hardware and software modules. Examples of processors 1304 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1304 may include specialized processors that perform specific functions, and that may be configured, augmented or controlled by one of the software modules 1316. The one or more processors 1304 may be configured through a combination of software modules 1316 loaded during initialization, and further configured by loading or unloading one or more software modules 1316 during operation.

In the illustrated example, the processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including the one or more processors 1304, and storage 1306. Storage 1306 may include memory devices and mass storage devices, and may be referred to herein as computer-readable media and/or processor-readable media. The bus 1310 may also link various other circuits such as timing sources, timers, peripherals, voltage regulators, and power management circuits. A bus interface 1308 may provide an interface between the bus 1310 and one or more transceivers 1312a, 1312b. A transceiver 1312a, 1312b may be provided for each networking technology supported by the processing circuit. In some instances, multiple networking technologies may share some or all of the circuitry or processing modules found in a transceiver 1312a, 1312b. Each transceiver 1312a, 1312b provides a means for communicating with various other apparatus over a transmission medium. In one example, a transceiver 1312a may be used to couple the apparatus 1300 to a multi-wire bus. In another example, a transceiver 1312b may be used to connect the apparatus 1300 to a radio access network. Depending upon the nature of the apparatus 1300, a user interface 1318 (e.g., keypad, display, speaker, microphone, joystick) may also be provided, and may be communicatively coupled to the bus 1310 directly or through the bus interface 1308.

A processor 1304 may be responsible for managing the bus 1310 and for general processing that may include the execution of software stored in a computer-readable medium that may include the storage 1306. In this respect, the processing circuit 1302, including the processor 1304, may be used to implement any of the methods, functions and techniques disclosed herein. The storage 1306 may be used for storing data that is manipulated by the processor 1304 when executing software, and the software may be configured to implement certain methods disclosed herein.

One or more processors 1304 in the processing circuit 1302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1306 or in an external computer-readable medium. The external computer-readable medium and/or storage 1306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1306 may also include, by way of example, a carrier wave, a transmission line, and any other suitable medium for transmitting software and/or instructions that may be accessed and read by a computer. Computer-readable medium and/or the storage 1306 may reside in the processing circuit 1302, in the processor 1304, external to the processing circuit 1302, or be distributed across multiple entities including the processing circuit 1302. The computer-readable medium and/or storage 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1306 may maintain software maintained and/or organized in loadable code segments, modules, applications, programs, etc., which may be referred to herein as software modules 1316. Each of the software modules 1316 may include instructions and data that, when installed or loaded on the processing circuit 1302 and executed by the one or more processors 1304, contribute to a run-time image 1314 that controls the operation of the one or more processors 1304. When executed, certain instructions may cause the processing circuit 1302 to perform functions in accordance with certain methods, algorithms and processes described herein.

Some of the software modules 1316 may be loaded during initialization of the processing circuit 1302, and these software modules 1316 may configure the processing circuit 1302 to enable performance of the various functions disclosed herein. For example, some software modules 1316 may configure internal devices and/or logic circuits 1322 of the processor 1304, and may manage access to external devices such as a transceiver 1312a, 1312b, the bus interface 1308, the user interface 1318, timers, mathematical coprocessors, and so on. The software modules 1316 may include a control program and/or an operating system that interacts with interrupt handlers and device drivers, and that controls access to various resources provided by the processing circuit 1302. The resources may include memory, processing time, access to a transceiver 1312a, 1312b, the user interface 1318, and so on.

One or more processors 1304 of the processing circuit 1302 may be multifunctional, whereby some of the software modules 1316 are loaded and configured to perform different functions or different instances of the same function. The one or more processors 1304 may additionally be adapted to manage background tasks initiated in response to inputs from the user interface 1318, the transceiver 1312a, 1312b, and device drivers, for example. To support the performance of multiple functions, the one or more processors 1304 may be configured to provide a multitasking environment, whereby each of a plurality of functions is implemented as a set of tasks serviced by the one or more processors 1304 as needed or desired. In one example, the multitasking environment may be implemented using a timesharing program 1320 that passes control of a processor 1304 between different tasks, whereby each task returns control of the one or more processors 1304 to the timesharing program 1320 upon completion of any outstanding operations and/or in response to an input such as an interrupt. When a task has control of the one or more processors 1304, the processing circuit is effectively specialized for the purposes addressed by the function associated with the controlling task. The timesharing program 1320 may include an operating system, a main loop that transfers control on a round-robin basis, a function that allocates control of the one or more processors 1304 in accordance with a prioritization of the functions, and/or an interrupt driven main loop that responds to external events by providing control of the one or more processors 1304 to a handling function.

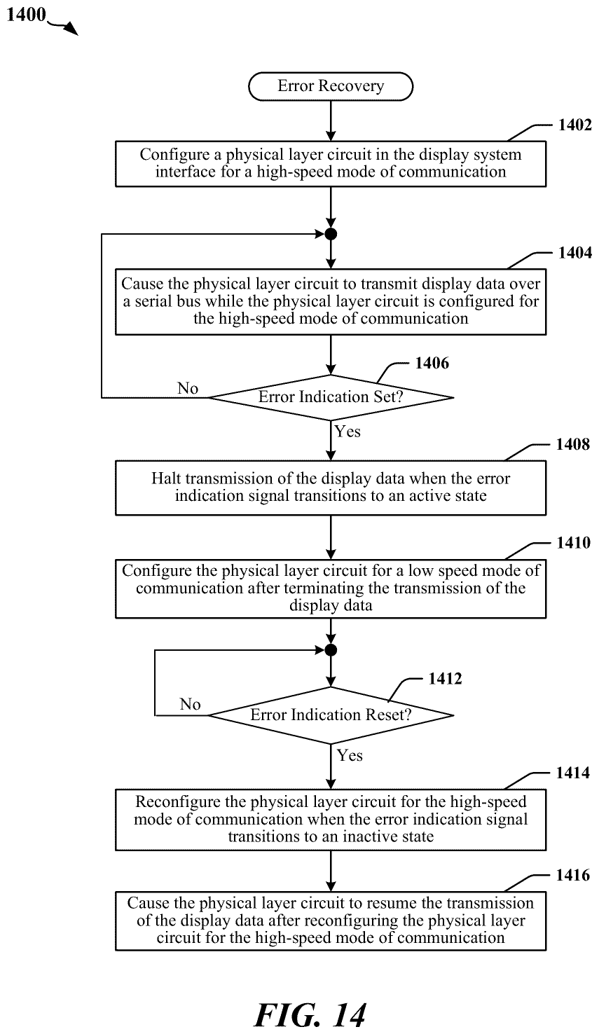

FIG. 14 is a flowchart 1400 of an error recovery method for a display system interface. The method may be implemented in a display subsystem that is configured in accordance with certain aspects of this disclosure. In one example, a mobile communication device includes a serial data link operated in accordance with C-PHY or D-PHY protocols. Portions or all of the method may be performed using a controller or other processor such as a finite state machine in the mobile communication device.

In the illustrated method, at block 1402, a controller may configure a physical layer circuit in the display system interface for a high-speed mode of communication. At block 1404, the controller may cause the physical layer circuit to transmit display data over a serial bus while the physical layer circuit is configured for the high-speed mode of communication. The controller may monitor an error indicator at block 1406. The error indicator may indicate when a transmission error has been detected by a receiver. In one example, the controller monitors an error indication signal that transitions to an active state to indicate that a transmission error has been detected at the receiving device. If a transmission error is not indicated, then the controller may continue transmission of the display data at block 1404 with continuous or continual monitoring of the error indicator at block 1406. When the error indicator is asserted or set, a transmission error is indicated and the method may proceed at block 1408.

At block 1408, the controller may halt transmission of the display data when the error indication signal transitions to an active state, for example. At block 1410, the controller may configure the physical layer circuit for a low-power mode of communication after terminating the transmission of the display data. The controller may continue to monitor the error indicator at block 1412 while the error indicator remains asserted or set. In some examples, a timeout counter is initiated and the receiving device may be reset when the timeout counter reaches zero or a preconfigured value. Meanwhile, the controller may continue monitoring the error indicator at block 1412. When the error indicator is de-asserted or reset the method may proceed at block 1414.

At block 1414, the controller may reconfigure the physical layer circuit for the high-speed mode of communication when the error indication signal transitions to an inactive state. At block 1416, the controller may cause the physical layer circuit to resume the transmission of the display data after reconfiguring the physical layer circuit for the high-speed mode of communication.

In certain examples, the controller may cause the physical layer circuit to transmit a control sequence while the physical layer circuit is configured for the low-power mode of communication. The control sequence may be transmitted in a signal that has a nominal 1.2 volt amplitude and includes an LP-11 state that has a maximum voltage amplitude configured for the signal. The physical layer circuit may be configured to transmit the display data over the serial bus in a signal that has a nominal 200 millivolt amplitude. The controller may cause the physical layer circuit to transmit a start sequence in a signal that has a nominal 200 millivolt amplitude. In certain implementations, the start sequence includes a settle period that follows the LP-11 state. The settle period may have has a duration provided in accordance with a D-PHY protocol defined by the MIPI Alliance. In certain implementations, the start sequence includes a preamble that is transmitted after the LP-11 state. The preamble may be configured in accordance with a C-PHY protocol defined by the MIPI Alliance.

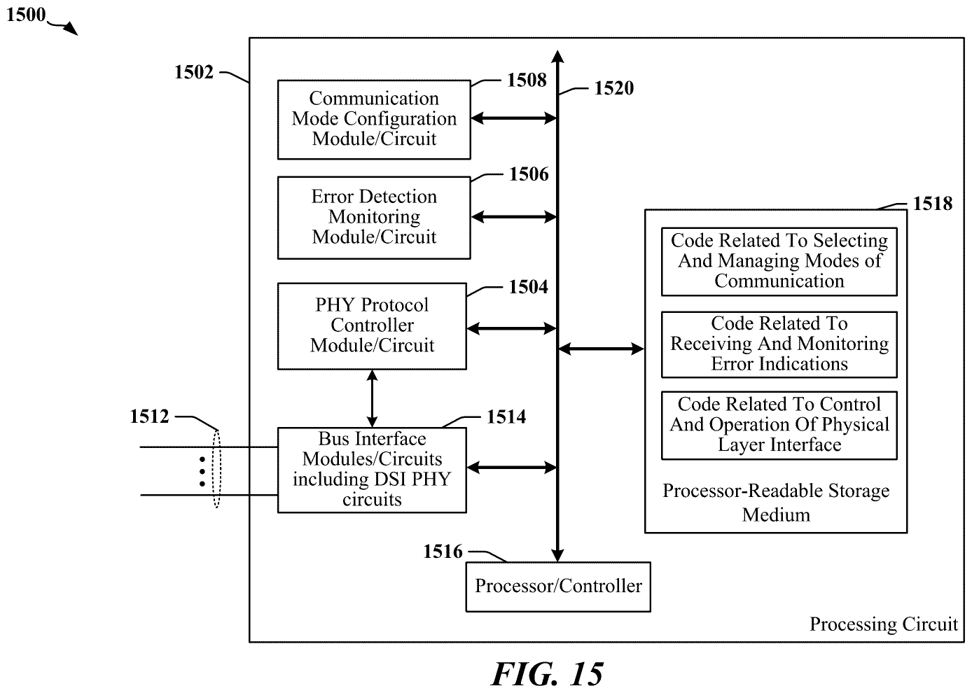

FIG. 15 is a diagram illustrating a first example of a hardware implementation for an apparatus 1500 employing a processing circuit 1502. The processing circuit typically has one or more microprocessors, microcontrollers, digital signal processors, sequencers and/or state machines, represented generally by the processors 1516. The processing circuit 1502 may be implemented with a bus architecture, represented generally by the bus 1520. The bus 1520 may include any number of interconnecting buses and bridges depending on the specific application of the processing circuit 1502 and the overall design constraints. The bus 1520 links together various circuits including one or more processors 1516, the modules or circuits 1504, 1506 and 1508 and the processor-readable storage medium 1518. A bus interface circuit and/or module 1514 may be provided to support communications over a serial data link 1512. The bus 1520 may also link various other circuits such as timing sources, peripherals, voltage regulators, and power management circuits, which are well known in the art, and therefore, will not be described any further. The processors 1516 may be responsible for general processing, including the execution of software, code and/or instructions stored on the processor-readable storage medium 1518. The processor-readable storage medium 1518 may include a non-transitory storage medium. The software, when executed by the processors 1516, causes the processing circuit 1502 to perform the various functions described supra for any particular apparatus. The processor-readable storage medium may be used for storing data that is manipulated by the processors 1516 when executing software. The processing circuit 1502 further includes at least one of the modules 1504, 1506 and 1508. The modules 1504, 1506 and 1508 may be software modules running in the processors 1516, resident/stored in the processor-readable storage medium 1518, one or more hardware modules coupled to the processors 1516, or some combination thereof. The modules 1504, 1506 and 1508 may include microcontroller instructions, state machine configuration parameters, or some combination thereof.

In one configuration, the apparatus 1500 includes modules and/or circuits 1504 adapted to control operations of the bus interface circuit and/or module 1514 and to manage transmissions over the serial data link 1512. The apparatus 1500 may include modules and/or circuits 1506 adapted to monitor and respond to indicators of transmission errors, including indicators provided by a receiving device. The apparatus 1500 may include modules and/or circuits 1508 adapted to configure modes of communication over the serial data link 1512.

The apparatus 1500 may include means for transmitting display data over a serial bus, including a physical layer circuit configurable for multiple modes of communication. The apparatus 1500 may include means for determining that a transmission error has been detected at the receiving device when the physical layer circuit is configured for a high-speed mode of communication. The means for determining that the transmission error has been detected may be configured to provide an indication of the transmission error. The transmission of the display data may be halted when the indication of the transmission error is set to a first state. The physical layer circuit may be configured for a low-power mode of communication when the indication of the transmission error transitions to the first state and the physical layer circuit may be reconfigured for the high-speed mode of communication when the indication of the transmission error transitions to a second state. The physical layer circuit may be configured to resume the transmission of the display data after the physical layer circuit is reconfigured for the high-speed mode of communication. The means for determining that the transmission error has been detected at the receiving device may include an error indication signal.

In certain implementations, the means for transmitting the display data is configured to transmit a control sequence through the physical layer circuit while the physical layer circuit is configured for the low-power mode of communication. The control sequence may be transmitted in a signal that has a nominal 1.2 volt amplitude and includes an LP-11 state that has a maximum voltage amplitude configured for the signal. The physical layer circuit may be configured to transmit the display data over the serial bus in a signal that has a nominal 200 millivolt amplitude. The means for transmitting the display data may be configured to transmit a start sequence in a signal that has a nominal 200 millivolt amplitude. In one example, the start sequence may include a settle period that follows the LP-11 state. The settle period may have a duration provided in accordance with a D-PHY protocol defined by the MIPI Alliance. In another example, the start sequence includes a preamble that is transmitted after the LP-11 state. The preamble may be configured in accordance with a C-PHY protocol defined by the MIPI Alliance.

In one example, the apparatus 1500 is configured to operate as a mobile communication device that has a wireless transceiver configured to transmit and receive RF signals through one or more antennas, a bus interface circuit and/or module 1514 configured to couple the apparatus 1500 to a serial data link, and a controller or other processor. In this and other examples, the apparatus 1500 includes a display system interface. The display system interface has a physical layer circuit coupled to a serial bus and a controller. The display system interface is configurable to operate in accordance with MIPI Alliance DSI standards or specifications. The controller may be configured to monitor an error indication signal received from a receiving device coupled to the serial bus. The controller may be further configured to configure the physical layer circuit for a high-speed mode of communication, cause the physical layer circuit to transmit display data over the serial bus while the physical layer circuit is configured for the high-speed mode of communication, halt transmission of the display data when the error indication signal transitions to an active state, configure the physical layer circuit for a low-power mode of communication after terminating the transmission of the display data, reconfigure the physical layer circuit for the high-speed mode of communication when the error indication signal transitions to an inactive state and cause the physical layer circuit to resume the transmission of the display data after reconfiguring the physical layer circuit for the high-speed mode of communication. In some instances, the error indication signal transitions to the active state to indicate that a transmission error has been detected at the receiving device.

In certain implementations, the controller is further configured to cause the physical layer circuit to transmit a control sequence while the physical layer circuit is configured for the low-power mode of communication. The control sequence may be transmitted in a signal that has a nominal 1.2 volt amplitude and includes an LP-11 state that has a maximum voltage amplitude configured for the signal. The physical layer circuit may be configured to transmit the display data over the serial bus in a signal that has a nominal 200 millivolt amplitude. The controller may be further configured to cause the physical layer circuit to transmit a start sequence in a signal that has a nominal 200 millivolt amplitude. In one example, the start sequence includes a settle period that follows the LP-11 state. The settle period may have a duration provided in accordance with a D-PHY protocol defined by the MIPI Alliance. In another example, the start sequence includes a preamble that is transmitted after the LP-11 state. The preamble may be configured in accordance with a C-PHY protocol defined by the MIPI Alliance.

The processor-readable storage medium 1518 may include instructions that cause the processing circuit 1502 to configure a physical layer circuit in the display system interface for a high-speed mode of communication, cause the physical layer circuit to transmit display data over a serial bus while the physical layer circuit is configured for the high-speed mode of communication, halt transmission of the display data when the error indication signal transitions to an active state, configure the physical layer circuit for a low-power mode of communication after terminating the transmission of the display data, reconfigure the physical layer circuit for the high-speed mode of communication when the error indication signal transitions to an inactive state, and cause the physical layer circuit to resume the transmission of the display data after reconfiguring the physical layer circuit for the high-speed mode of communication. The error indication signal may transition to the active state to indicate that a transmission error has been detected at the receiving device.

In certain examples, processor-readable storage medium 1518 may include instructions that cause the processing circuit 1502 to cause the physical layer circuit to transmit a control sequence while the physical layer circuit is configured for the low-power mode of communication. The control sequence may be transmitted in a signal that has a nominal 1.2 volt amplitude and includes an LP-11 state that has a maximum voltage amplitude configured for the signal. The physical layer circuit may be configured to transmit the display data over the serial bus in a signal that has a nominal 200 millivolt amplitude. The processor-readable storage medium 1518 may include instructions that cause the processing circuit 1502 to command the physical layer circuit to transmit a start sequence in a signal that has a nominal 200 millivolt amplitude. In one example, the start sequence includes a settle period that follows the LP-11 state. The settle period may have a duration provided in accordance with a D-PHY protocol defined by the MIPI Alliance. In another example, the start sequence includes a preamble that is transmitted after the LP-11 state.

The preamble may be configured in accordance with a C-PHY protocol defined by the MIPI Alliance.

Some implementation examples are described in the following numbered clauses:
1. A display system interface for a transmitting device comprising: a physical layer circuit coupled to a serial bus and configurable to operate in accordance with Mobile Industry Processor Interface (MIPI) Alliance display serial interface (DSI) specifications; and a controller configured to monitor an error indication signal received from a receiving device coupled to the serial bus, the controller being further configured to: configure the physical layer circuit for a high-speed mode of communication; cause the physical layer circuit to transmit display data over the serial bus while the physical layer circuit is configured for the high-speed mode of communication; halt transmission of the display data when the error indication signal transitions to an active state; configure the physical layer circuit for a low-power mode of communication after terminating the transmission of the display data; reconfigure the physical layer circuit for the high-speed mode of communication when the error indication signal transitions to an inactive state; and cause the physical layer circuit to resume the transmission of the display data after reconfiguring the physical layer circuit for the high-speed mode of communication.
2. The display system interface as described in clause 1, wherein the error indication signal transitions to the active state to indicate that a transmission error has been detected at the receiving device.
3. The display system interface as described in clause 1 or clause 2, wherein the controller is further configured to: cause the physical layer circuit to transmit a control sequence while the physical layer circuit is configured for the low-power mode of communication, wherein the control sequence is transmitted in a signal that has a nominal 1.2 volt amplitude and includes an LP-11 state that has a maximum voltage amplitude configured for the signal.
4. The display system interface as described in clause 3, wherein the physical layer circuit is configured to transmit the display data over the serial bus in a signal that has a nominal 200 millivolt amplitude.
5. The display system interface as described in clause 3 or clause 4, wherein the controller is further configured to: cause the physical layer circuit to transmit a start sequence in a signal that has a nominal 200 millivolt amplitude.
6. The display system interface as described in clause 5, wherein the start sequence comprises a settle period that follows the LP-11 state.
7. The display system interface as described in clause 6, wherein the settle period has a duration provided in accordance with a D-PHY protocol defined by the MIPI Alliance.
8. The display system interface as described in clause 5, wherein the start sequence comprises a preamble that is transmitted after the LP-11 state.
9. The display system interface as described in clause 8, wherein the preamble is configured in accordance with a C-PHY protocol defined by the MIPI Alliance.
10. An error recovery method for a display system interface, comprising: configuring a physical layer circuit in the display system interface for a high-speed mode of communication; causing the physical layer circuit to transmit display data over a serial bus while the physical layer circuit is configured for the high-speed mode of communication; halting transmission of the display data when an error indication signal transitions to an active state; configuring the physical layer circuit for a low-power mode of communication after terminating the transmission of the display data; reconfiguring the physical layer circuit for the high-speed mode of communication when the error indication signal transitions to an inactive state; and causing the physical layer circuit to resume the transmission of the display data after reconfiguring the physical layer circuit for the high-speed mode of communication.
11. The method as described in clause 10, wherein the error indication signal transitions to the active state to indicate that a transmission error has been detected at a receiving device.
12. The method as described in clause 10 or clause 11, further comprising: causing the physical layer circuit to transmit a control sequence while the physical layer circuit is configured for the low-power mode of communication, wherein the control sequence is transmitted in a signal that has a nominal 1.2 volt amplitude and includes an LP-11 state that has a maximum voltage amplitude configured for the signal.
13. The method as described in clause 12, wherein the physical layer circuit is configured to transmit the display data over the serial bus in a signal that has a nominal 200 millivolt amplitude.
14. The method as described in clause 12 or clause 13, further comprising: causing the physical layer circuit to transmit a start sequence in a signal that has a nominal 200 millivolt amplitude.
15. The method as described in clause 14, wherein the start sequence comprises a settle period that follows the LP-11 state.
16. The method as described in clause 15, wherein the settle period has a duration provided in accordance with a D-PHY protocol defined by the Mobile Industry Processor Interface (MIPI) Alliance.
17. The method as described in clause 14, wherein the start sequence comprises a preamble that is transmitted after the LP-11 state.
18. The method as described in clause 17, wherein the preamble is configured in accordance with a C-PHY protocol defined by the MIPI Alliance.
19. An apparatus, comprising: means for transmitting display data over a serial bus, including a physical layer circuit configurable for multiple modes of communication; and means for determining that a transmission error has been detected at a receiving device when the physical layer circuit is configured for a high-speed mode of communication, the means for determining that the transmission error has been detected being configured to monitor an indication of the transmission error, wherein transmission of the display data is halted when the indication of the transmission error transitions to a first state, wherein the physical layer circuit is configured for a low-power mode of communication when the indication of the transmission error transitions to the first state and the physical layer circuit is reconfigured for the high-speed mode of communication when the indication of the transmission error transitions to a second state, and wherein the physical layer circuit is configured to resume the transmission of the display data after the physical layer circuit is reconfigured for the high-speed mode of communication.
20. The apparatus as described in clause 19, wherein the indication of the transmission error comprises an error indication signal.
21. The apparatus as described in clause 19 or clause 20, wherein the means for transmitting the display data is configured to: transmit a control sequence through the physical layer circuit while the physical layer circuit is configured for the low-power mode of communication, wherein the control sequence is transmitted in a signal that has a nominal 1.2 volt amplitude and includes an LP-11 state that has a maximum voltage amplitude configured for the signal.
22. The apparatus as described in clause 21, wherein the physical layer circuit is configured to transmit the display data over the serial bus in a signal that has a nominal 200 millivolt amplitude.
23. The apparatus as described in clause 21 or clause 22, wherein the means for transmitting the display data is further configured to: transmit a start sequence in a signal that has a nominal 200 millivolt amplitude.
24. The apparatus as described in clause 23, wherein the start sequence comprises a settle period that follows the LP-11 state.
25. The apparatus as described in clause 24, wherein the settle period has a duration provided in accordance with a D-PHY protocol defined by the Mobile Industry Processor Interface (MIPI) Alliance.
26. The apparatus as described in clause 23, wherein the start sequence comprises a preamble that is transmitted after the LP-11 state.
27. The apparatus as described in clause 26, wherein the preamble is configured in accordance with a C-PHY protocol defined by the MIPI Alliance.
28. A processor readable storage medium comprising code for: configuring a physical layer circuit in the display system interface for a high-speed mode of communication; causing the physical layer circuit to transmit display data over a serial bus while the physical layer circuit is configured for the high-speed mode of communication; halting transmission of the display data when an error indication signal transitions to an active state; configuring the physical layer circuit for a low-power mode of communication after terminating the transmission of the display data; reconfiguring the physical layer circuit for the high-speed mode of communication when the error indication signal transitions to an inactive state; and causing the physical layer circuit to resume the transmission of the display data after reconfiguring the physical layer circuit for the high-speed mode of communication.
29. The storage medium as described in clause 28, further comprising code for: causing the physical layer circuit to transmit a control sequence while the physical layer circuit is configured for the low-power mode of communication, wherein the control sequence is transmitted in a signal that has a nominal 1.2 volt amplitude and includes an LP-11 state that has a maximum voltage amplitude configured for the signal, and wherein the physical layer circuit transmits the display data over the serial bus in a signal that has a nominal 200 millivolt amplitude.
30. The storage medium as described in clause 29, further comprising code for: causing the physical layer circuit to transmit a start sequence in a signal that has a nominal 200 millivolt amplitude, wherein the start sequence comprises a settle period that follows the LP-11 state when the physical layer circuit is configured in accordance with a D-PHY protocol defined by the Mobile Industry Processor Interface (MIPI) Alliance, and wherein the start sequence comprises a preamble that follows the LP-11 state when the physical layer circuit is configured in accordance with a C-PHY protocol defined by the MIPI Alliance.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A display system interface for a transmitting device, comprising:
a physical layer circuit coupled to a serial bus and configurable to operate in accordance with Mobile Industry Processor Interface (MIPI) Alliance display serial interface (DSI) specifications; and
a controller configured to monitor an error indication signal received from a receiving device coupled to the serial bus, the controller being further configured to:
configure the physical layer circuit for a high-speed mode of communication;
cause the physical layer circuit to transmit display data over the serial bus while the physical layer circuit is configured for the high-speed mode of communication;
halt transmission of the display data when the error indication signal transitions to an active state;
configure the physical layer circuit for a low-power mode of communication after terminating the transmission of the display data;
reconfigure the physical layer circuit for the high-speed mode of communication when the error indication signal transitions to an inactive state; and
cause the physical layer circuit to resume the transmission of the display data after reconfiguring the physical layer circuit for the high-speed mode of communication.

2. The display system interface of claim 1, wherein the error indication signal transitions to the active state to indicate that a transmission error has been detected at the receiving device.

3. The display system interface of claim 1, wherein the controller is further configured to:
cause the physical layer circuit to transmit a control sequence while the physical layer circuit is configured for the low-power mode of communication, wherein the control sequence is transmitted in a signal that has a nominal 1.2 volt amplitude and includes an LP-11 state that has a maximum voltage amplitude configured for the signal.

4. The display system interface of claim 3, wherein the physical layer circuit is configured to transmit the display data over the serial bus in a signal that has a nominal 200 millivolt amplitude.

5. The display system interface of claim 3, wherein the controller is further configured to:
cause the physical layer circuit to transmit a start sequence in a signal that has a nominal 200 millivolt amplitude.

6. The display system interface of claim 5, wherein the start sequence comprises a settle period that follows the LP-11 state.

7. The display system interface of claim 6, wherein the settle period has a duration provided in accordance with a D-PHY protocol defined by the MIPI Alliance.

8. The display system interface of claim 5, wherein the start sequence comprises a preamble that is transmitted after the LP-11 state.

9. The display system interface of claim 8, wherein the preamble is configured in accordance with a C-PHY protocol defined by the MIPI Alliance.

10. An error recovery method for a display system interface, comprising:
configuring a physical layer circuit in the display system interface for a high-speed mode of communication;
causing the physical layer circuit to transmit display data over a serial bus while the physical layer circuit is configured for the high-speed mode of communication;
halting transmission of the display data when an error indication signal transitions to an active state;
configuring the physical layer circuit for a low-power mode of communication after terminating the transmission of the display data;
reconfiguring the physical layer circuit for the high-speed mode of communication when the error indication signal transitions to an inactive state; and
causing the physical layer circuit to resume the transmission of the display data after reconfiguring the physical layer circuit for the high-speed mode of communication.

11. The method of claim 10, wherein the error indication signal transitions to the active state to indicate that a transmission error has been detected at a receiving device.

12. The method of claim 10, further comprising:
causing the physical layer circuit to transmit a control sequence while the physical layer circuit is configured for the low-power mode of communication, wherein the control sequence is transmitted in a signal that has a nominal 1.2 volt amplitude and includes an LP-11 state that has a maximum voltage amplitude configured for the signal.

13. The method of claim 12, wherein the physical layer circuit is configured to transmit the display data over the serial bus in a signal that has a nominal 200 millivolt amplitude.

14. The method of claim 12, further comprising:
causing the physical layer circuit to transmit a start sequence in a signal that has a nominal 200 millivolt amplitude.

15. The method of claim 14, wherein the start sequence comprises a settle period that follows the LP-11 state.

16. The method of claim 15, wherein the settle period has a duration provided in accordance with a D-PHY protocol defined by the Mobile Industry Processor Interface (MIPI) Alliance.

17. The method of claim 14, wherein the start sequence comprises a preamble that is transmitted after the LP-11 state.

18. The method of claim 17, wherein the preamble is configured in accordance with a C-PHY protocol defined by the MIPI Alliance.

19. An apparatus, comprising:
means for transmitting display data over a serial bus, including a physical layer circuit configurable for multiple modes of communication; and
means for determining that a transmission error has been detected at a receiving device when the physical layer circuit is configured for a high-speed mode of communication, the means for determining that the transmission error has been detected being configured to monitor an indication of the transmission error,
wherein transmission of the display data is halted when the indication of the transmission error transitions to a first state,
wherein the physical layer circuit is configured for a low-power mode of communication when the indication of the transmission error transitions to the first state and the physical layer circuit is reconfigured for the high-speed mode of communication when the indication of the transmission error transitions to a second state, and
wherein the physical layer circuit is configured to resume the transmission of the display data after the physical layer circuit is reconfigured for the high-speed mode of communication.

20. The apparatus of claim 19, wherein the indication of the transmission error comprises an error indication signal.

21. The apparatus of claim 19, wherein the means for transmitting the display data is configured to:
transmit a control sequence through the physical layer circuit while the physical layer circuit is configured for the low-power mode of communication, wherein the control sequence is transmitted in a signal that has a nominal 1.2 volt amplitude and includes an LP-11 state that has a maximum voltage amplitude configured for the signal.

22. The apparatus of claim 21, wherein the physical layer circuit is configured to transmit the display data over the serial bus in a signal that has a nominal 200 millivolt amplitude.

23. The apparatus of claim 21, wherein the means for transmitting the display data is further configured to:
transmit a start sequence in a signal that has a nominal 200 millivolt amplitude.

24. The apparatus of claim 23, wherein the start sequence comprises a settle period that follows the LP-11 state.

25. The apparatus of claim 24, wherein the settle period has a duration provided in accordance with a D-PHY protocol defined by the Mobile Industry Processor Interface (MIPI) Alliance.

26. The apparatus of claim 23, wherein the start sequence comprises a preamble that is transmitted after the LP-11 state.

27. The apparatus of claim 26, wherein the preamble is configured in accordance with a C-PHY protocol defined by the MIPI Alliance.

28. A processor readable storage medium comprising code for:
configuring a physical layer circuit in a display system interface for a high-speed mode of communication;
causing the physical layer circuit to transmit display data over a serial bus while the physical layer circuit is configured for the high-speed mode of communication;
halting transmission of the display data when an error indication signal transitions to an active state;
configuring the physical layer circuit for a low-power mode of communication after terminating the transmission of the display data;
reconfiguring the physical layer circuit for the high-speed mode of communication when the error indication signal transitions to an inactive state; and
causing the physical layer circuit to resume the transmission of the display data after reconfiguring the physical layer circuit for the high-speed mode of communication.

29. The storage medium of claim 28, further comprising code for:
causing the physical layer circuit to transmit a control sequence while the physical layer circuit is configured for the low-power mode of communication, wherein the control sequence is transmitted in a signal that has a nominal 1.2 volt amplitude and includes an LP-11 state that has a maximum voltage amplitude configured for the signal, and wherein the physical layer circuit transmits the display data over the serial bus in a signal that has a nominal 200 millivolt amplitude.

30. The storage medium of claim 29, further comprising code for:
causing the physical layer circuit to transmit a start sequence in a signal that has a nominal 200 millivolt amplitude,
wherein the start sequence comprises a settle period that follows the LP-11 state when the physical layer circuit is configured in accordance with a D-PHY protocol defined by the Mobile Industry Processor Interface (MIPI) Alliance, and
wherein the start sequence comprises a preamble that follows the LP-11 state when the physical layer circuit is configured in accordance with a C-PHY protocol defined by the MIPI Alliance.
